(19) United States
(12) Patent Application Publication
(10) Pub. No.: US 2017/0249460 A1
(43) Pub. Date: Aug. 31, 2017

(54) PROVABLY SECURE VIRUS DETECTION

(71) Applicants: THE REGENTS OF THE UNIVERSITY OF CALIFORNIA, Oakland, CA (US); GEORGIA TECH RESEARCH CORPORATION, Atlanta, GA (US)

(72) Inventors: Richard J. Lipton, Atlanta, GA (US); Rafail Ostrovsky, Los Angeles, CA (US); Vassilis Zikas, Zurich (CH)

(73) Assignee: THE REGENTS OF THE UNIVERSITY OF CALIFORNIA, Oakland, CA (US)

(21) Appl. No.: 15/513,556

(22) PCT Filed: Sep. 23, 2015
(86) PCT No.: PCT/US15/51779

§ 371 Date: Mar. 23, 2017

Related U.S. Application Data
(62) Division of application No. 62/054,160, filed on Sep. 23, 2014.

(51) Int. Cl. G06F 21/54; G06F 21/56; G06F 21/60

(52) U.S. Cl. CPC G06F 21/54; G06F 21/602; G06F 21/566

(57) ABSTRACT

We present the first provably secure defense against software viruses. We hide a secret in the program code in a way that ensures that, as long as the system does not leak information about it, any injection of malware will destroy the secret with very′-high probability. Once the secret is destroyed, its destruction and therefore also the injection of malware will be quickly detected.

### CROSS-REFERENCE TO RELATED APPLICATION(S)

This application claims priority under 35 U.S.C. §119(e) to U.S. Provisional Patent Application Ser. No. 62/054,160, “Provably Secure Virus Detection,” filed Sep. 23, 2014. The subject matter of all of the foregoing is incorporated herein by reference in their entirety.

### BACKGROUND

1. Field of the Invention

This disclosure relates generally to virus detection.

2. Description of Related Art

It is desirable to make computer systems safe from the insertion of malware, commonly referred to as viruses. The problem is that almost all programs can be attacked by adversaries who install their own code into a program—malware—and thereby take over the system. This allows them to do anything: steal credit card information, get passwords to websites, get health information, destroy industrial controllers, and in general cause untold damage and havoc. And this is only getting worse, as attackers become more sophisticated and as computers are used everywhere, in almost everything. As a result, there have been many efforts to address this problem.

Perhaps the most common defense mechanism in practice is to block the path the attacker uses to inject and execute its malware. The respective solutions typically aim to protect specific memory vulnerabilities, such as buffer overflow attacks. Most of the attacks of this type aim to overwrite control-data (i.e., data that influence the program stack/counter) to modify the program flow and execute some malicious injected code.

Other defense approaches monitor the system calls that the program makes (i.e., its interfaces to the operating system) to detect abnormal behavior and attempt to ensure control-flow integrity by checking that the software execution path is within a precomputed control-flow tree. Yet another line of suggested countermeasures include software-fault isolation (the program is restricted to only access a specific memory range which is thoroughly verified and safeguarded) and data-protection mechanisms (e.g., by means of water-marking) some of which offer even active protection, i.e., might even repair the compromised data.

Most recently, software diversity has been thought of as a promising weapon in the arsenal against malware injection. Inspired by biological systems, where diversification is a prominent venue for resiliency, software diversification uses randomization to ensure that each system executes a unique (or even several unique) copies of the software, so that an attack which succeeds against some systems will most likely fail against other systems (or even when launched twice against the same system). A typical example is address obfuscation (aka address space randomization), which, roughly, compiles the software to randomize the locations of program data and instructions so that the attacker is most likely to follow an invalid computation path and thus provoke a crash or fault with good probability. Such a randomization might be done to the program source at compilation time, or in some cases to the binary (machine code) at loading time.

Another example of software diversification is instruction set randomization (ISR) which randomizes the instruction set. Informally, ISR uses a secret key K to compile the set of (machine code) instructions that the software is to execute into a completely random set of instructions. This is typically done by one-time-pad encrypting the instructions with a pseudo-random key generated by a pseudo-random generator seeded by K; more recent suggestions use AES encryption for this purpose. When the program is loaded to the memory, an emulator who is given the key K decrypts on-the-fly the randomized instructions and executes them. The expectation is that if a virus is injected (before the emulation) then the decryption is most likely to map it to an incoherent sequence that will most likely provoke a crash of some other type of fault.

This technique has several limitations. First, it is restricted with respect to the points in the execution path where the virus injection might occur, e.g., the virus cannot affect the emulator. Second, suggested ISR-based solutions typically protect only the code and not the program data. Third, depending on the actual software, on-the-fly compilation might incur a considerable slowdown on the program execution. Finally, ISR solutions (especially the one-time pad-based) make the system sustainable to code-reuse attacks (aka return oriented programming (ROP)) where the attacker (re)-uses parts of the actual code to perform its attack.

More recently, the idea of booby trapping software has been suggested. At a high level, some booby trap code is planted on the program executable which, when executed, initiates some fault reporting mechanism. However, to date, no concrete description, implementation, or formal security statement for a booby trapping mechanism has been provided.

The above approaches are usually heuristics and are not formally proved to be neither efficient nor effective. Rather, their performance and accuracy is typically experimentally validated. In fact, many of these security countermeasures experiments indicate a potentially undesirable tradeoff between between security and accuracy. Finally, many of them are ad hoc patches targeted to a single or a small class of vulnerabilities caused by malware injections.

On the more theoretical side of the security literature, cryptography offers security solutions which are backed by rigorous mathematical proofs instead of experimental benchmarks. Examples here include message authentication codes (MACs) and digital signatures for protecting data integrity, secure computation and homomorphic encryption for protecting data confidentiality, and many others. It is fair to say, though, that the cryptographic literature has mostly overlooked the problem of malicious software injection, in particular its practical aspects. One notable exception is the recent work which relies on a new class of codes called non-malleable codes which, roughly, are resilient to oblivious tampering. Nonetheless, in contrast to the solutions mentioned in the previous section, most of the cryptographic protocols are theoretical and/or adopt a too abstract model of computation which makes them to some extent incompatible to real-world threats.

An example of a primitive which recently attracted the spotlight within the cryptographic community is program obfuscation. A program can be rewritten in a way that one cannot get any information about it other than the input/output behavior of the function it computes. Both feasibility solution and impossibility results of great theoretical interest were proved. However, existing solutions are impractical and even the biggest optimists do not see how this primitive can be brought to practice any time soon. Indeed, the existing techniques turn short, simple programs into huge and slow programs. Furthermore their security lies on new computational hardness assumptions that have not yet been thoroughly attacked and evaluated.

### SUMMARY

The present disclosure overcomes the limitations of the prior art by hiding a secret in the program code in a way that ensures that, as long as the system does not leak information about it, any injection of malware will destroy the secret with very high probability. Once the secret is destroyed, its destruction and therefore also the injection of malware will be quickly detected.

In one aspect, let W be a program that we wish to protect from malware. We recompile W to \tilde{W}. The idea is that W and \tilde{W} must compute the same thing, run in about the same time, and yet \tilde{W} must be able to detect itself against the insertion of malware. The protected program \tilde{W} operates normally most of the time. Periodically it is challenged by another machine to prove that it “knows” a secret key K. This key is known only to \tilde{W} and not to the attacker. If \tilde{W} has not been attacked, then it simply uses the key K to answer the challenge and thus proves that it is still operating properly. We also arrange \tilde{W} so that no matter how the injection of malware has happened, the key K is lost. The attacker's very injection will have changed the state of \tilde{W} so that it is now in a state that no longer knows the key K.

In one approach, we distribute the key K all through memory by using a secret sharing. We break the key K into many pieces, called key shares, which are placed throughout all of the system's memory and are interleaved with words of W. Our secret sharing allows K to be reconstructed only if all the pieces are left untouched. If any are changed in any way, then it is impossible to reconstruct the key. Obviously, if there has been no attack, then in normal operation \tilde{W} can reconstruct the key from the pieces and answer the challenges. However, if the pieces are not all intact, then \tilde{W} will be unable to answer the next challenge.

In another aspect, we arrange that \tilde{W} can be attacked at any time, including when the system computing the response has collected all the key shares and reconstructed the key K. This is a very dangerous time, since if \tilde{W} is attacked at this moment the fact that key shares are destroyed does not matter. The attacker can simply use the reconstructed key K. Such time-of-check-time-of-use (TOCTOU) attacks can be avoided by using two keys K₁ and K₂ in tandem. Both are stored via secret sharing as before, but now one must have both in order to answer the challenges. We arrange that \tilde{W} only reconstructs one key at a time and this means that an attacker injecting a long-enough virus must destroy either or both of the keys.

In yet another aspect, we treat the case of very small viruses (i.e., ones that consist of a single bit or just a few bits) and viruses that know (or guess) the exact memory locations of key shares in advance and therefore might not need to overwrite them. We armor our system to defend even against such tiny/informed viruses by employing an additional lightweight cryptographic primitive, namely a message authentication code (in short, MAC). A MAC authenticates a value using a random key, so that an attacker without access to the key cannot change the value without being detected. We use the MACs in a straightforward and efficient manner. We authenticate each word in W using adjacent shares of the keys K₁ and K₂ (also) as MAC keys, and require that for any word that is loaded from the random access memory, the CPU verifies the corresponding MAC before further processing the word. Thus, if the MAC does not check out we detect it (and immediately destroy the key), and if the injection changes the MAC keys, the attacker loses one of the shares of one of the two secrets, and we detect that as well.

We enforce the above checks by assuming a modified CPU architecture (with only very small amount of additional computation, so the CPU power consumption would only be minimally affected.) More specifically, to get the most out of the MAC functionality, when the CPU executes the program, it verifies authenticity of the words it loads from the memory. That is, the load operation of the CPU loads a block of several words, which is already the case in most modern CPUs. The block includes the program word, the MAC-tag and the corresponding keys. The CPU checks with every load instruction that the MAC verifies before further processing the word. Importantly, our MAC uses just one field addition and one field multiplication per authentication/verification. The circuits required to perform these operations are actually trivial compared to the modern CPU complexity and are part of many existing CPU specifications.

In addition, instead of using the actual key shares in the generation/verification of the MAC tag, we use their hash-values. This ensures that the virus cannot manipulate the keys and forge a consistent MAC unless he overwrites a large part of them.

### BRIEF DESCRIPTION OF THE DRAWINGS

Embodiments of the disclosure have other advantages and features which will be more readily apparent from the following detailed description and the appended claims, when taken in conjunction with the accompanying drawings, in which:

FIG. 1A is a block diagram illustrating a compilation stage for a virus detection scheme.

FIG. 1B is a block diagram illustrating a challenge-response stage for a virus detection scheme.

FIG. 2A is a diagram of the virus attack game [symbol] .

FIG. 2B is a diagram of the repeated detection virus attack game τ [symbol] .

FIG. 2C is a diagram of the virus attack game without self-responsiveness

[symbol]

FIG. 3 illustrates a transformation from W to \tilde{W}.

FIG. 4A is a diagram of the procedure Spread, for insertion of key shares.

FIG. 4B is a diagram of Compile₁ for VDS [symbol] ₁, which is secure without self-responsiveness.

FIG. 4C is a diagram of Response, for VDS [symbol] ₁.

FIG. 4D is a diagram of the inverse procedure Spread⁻¹.

FIG. 5A is a diagram of Compile₂ for VDS [symbol] ₂, which is secure in the repeated detection game.

FIG. 5B is a diagram of Challenge₂ for VDS [symbol] ₂.

FIG. 5C is a diagram of Response₂ for VDS [symbol] ₂.

FIG. 6A is a diagram of the instruction read_auth.

FIG. 6B is a diagram of the instruction write_auth.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

The following description is organized as follows:

### 1. Overview

### 2. Preliminaries and Notation

### 3. Modelling Computation

3.1 Random Access Machine

3.2 Software Execution

3.3 Virus Injection

### 4. Virus Detection Schemes

4.1 VDS Model

4.2 VDS Security Properties

4.3 Modelling Virus Vulnerability

### 5. Some VDS Examples

5.1 A VDS without Self-Responsiveness

5.2 A VDS with Self-Responsiveness

5.3 A VDS with Standard Security

5.4 A VDS Secure against Short Viruses

### 6. Further Extensions

### 1. Overview

The following disclosure describes various virus detection schemes (VDS) for protecting software against arbitrary malicious code injection. In one aspect, the approach uses the fact that an attacker who injects some malware into the system, no matter how clever, no matter when or how he inserts his malware, changes the state of the system he is attacking. The approach is to compile the system to such a state so that any such change will be caught with arbitrary high probability, preferably in a manner that can be proven to be secure and without sacrificing performance.

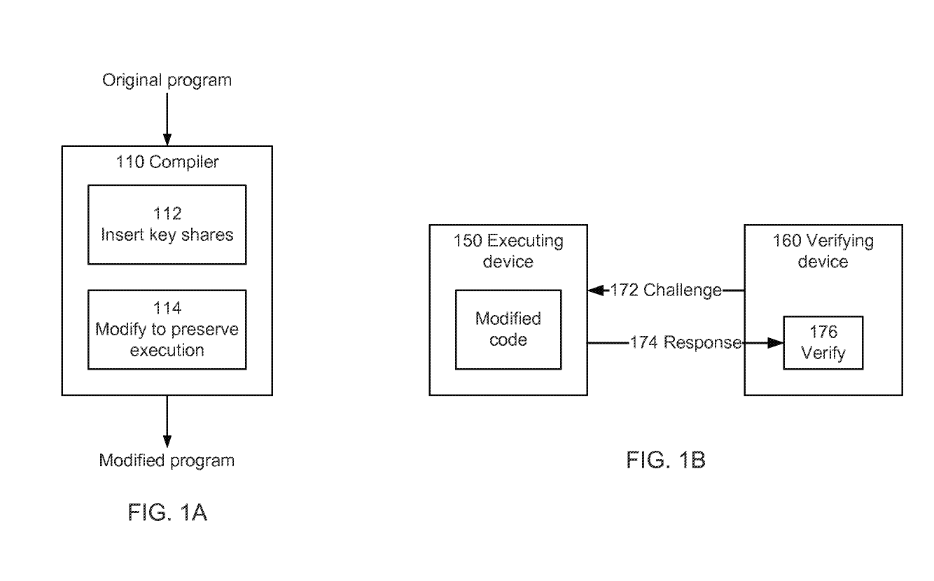

FIG. 1A is a block diagram of such a VDS. The VDS uses a compiler 110, which compiles any given program W (including its data) into a modified program \tilde{W}. The modified program \tilde{W} performs the same computation as the original program W but allows us to detect viruses injected in the memory at any point of the execution path. As shown in FIG. 1B, the detection is done via a challenge-response mechanism which is implemented between the machine 150 executing the modified program \tilde{W} and a verifying external device 160.

In the example of FIG. 1, the original program W is stored as words in a computer memory. The compiler 110 then performs two functions. It inserts 112 key shares at memory locations between the original program words. The original program words are spread out in memory to make space for the key shares. The key shares are for a key set (i.e., one or more secret keys), which is used in the challenge-response protocol. If the key shares are modified, then the key set is lost, which will cause a failure in the challenge-response protocol. In addition, the compiler 110 modifies 114 the original program so that the original program words still execute in the same order. For example, if the original program words are spread out in memory, then the compiler 110 may insert jump instructions, either implicit or explicit, to account for the new memory locations of the original program words. Note that the input W to the compiler 110 can be binary code, so that source code is not required for this.

The key shares are interspersed with the original program words so that injection of a virus into a contiguous block will modify a key share with high probability. The modification will then be detected by the challenge-response mechanism. In FIG. 1B, the verifying device 160 issues a challenge 172 based on the key set. The executing device 150 makes a response 174 based on the words contained in memory. The verifying device 160 can then verify 176 from the received response whether any key shares have been modified.

### 2. Preliminaries and Notation

Throughout this description, we assume an (often implicit) security parameter denoted as k. For a finite set S we denote by

$$s {←}^{\$} S$$

the operation of choosing s from S uniformly at random. For a randomized algorithm B we denote by B(x; r) the output of B on input x and random coins r. To avoid always explicitly writing the coins r, we shall denote by

$$y {←}^{\$} B ( x )$$

the operation of running B on input x (and uniformly random coins) and storing the output on variable y. When B is deterministic then we write y←B(x) to denote the above operation. We use the standard definition of“negligible” and “overwhelming” (e.g., see Oded Goldreich. Foundations of Cryptography: Basic Tools, volume 1. Cambridge University Press, Cambridge, UK, 2001).

For a number n∈ [symbol] , we denote by [n] the set [n]={1, . . . , n}. Furthermore, for a string x∈{0,1}* we denote by Decimal(x)∈ [symbol] the decimal representation of x. Inversely, for a number x∈ [symbol] ₚ with log p≦k, we denote by Binₚ(x) the k-bit string (binary) representation of x. Finally, for strings x and y we denote their concatenation by x∥y.

Secret Sharing.

A perfect m-out-of-m secret sharing scheme allows a dealer to split a secret s into m pieces s₁, . . . , sₘ, called the shares so that someone who holds all m shares can recover the secret (correctness), but any m−1 shares give no information on the secret (privacy). In this work we use m-out-of-m sharings of strings s∈S={0,1}ⁿ, where n∈ [symbol] . A simple construction of such a scheme has the dealer choose all sᵢ's uniformly at random with the restriction that s=⊕ᵢ₌₁^{m}sᵢ. We refer to the above sharing as the XOR-sharing. An XOR-sharing of s is denoted as (s)=(s₁, . . . , sₘ).

### 3. Modelling Computation

In this section we provide an abstract specification of our model of computation. Since the goal of our work is to provide virus detection mechanisms that are applicable to modern computers, we tune our model to be an accurate abstraction of the way a modern computer executes a program. We use as basis the well known Random Access Machine (RAM) model but slightly adapt it to be closer to an abstract version of a modern computer following the von Neumann architecture. In a nutshell, this modification consists of assuming that both the program and the data are written into the RAM's random access memory which is polynomially bounded. In the literature, a RAM with this modification is usually called a Random Access Stored-Program machine (RASP). Along the way we also specify some terminology which demonstrates how such a RAM corresponds to modern computers.

### 3.1. Random Access Machine

A RAM [symbol] includes two components: A Random Access Memory (in short RMEM) and a Central Processing Unit (in short CPU). The memory RMEM is modeled as a vector of words, i.e., bit-strings of appropriate (fixed) length, where each component has some pre-defined address. In an actual computer, each of these words corresponds to a register in the random access memory which can be accessed (read and written) by the CPU according to some pre-defined addressing mechanism. The CPU includes a much smaller number of registers, as well as an instruction set I that defines which operations can be performed on the registers, and how data are loaded to/output from the CPU.

The RAM and the CPU communicate in fetch and execute cycles, aka CPU cycles, typically through a CPU bus. At times we refer to a CPU cycle as a round in the RAM's execution. In each such cycle, the CPU accesses the RMEM to read (load) a word to some of its registers, performs some basic operation from I on its local registers, e.g., adding two registers and storing their output on a third register, and (potentially) writes some word (the contents of some register) to a location in the memory RMEM. The location in RMEM from where the next word will be read is stored in a special integer-valued register denoted as pc (usually called the program counter) which unless there is a jump instruction (see below) is incremented by one in each CPU cycle. In the following we provide some details on the above components.

The Random Access Memory (RMEM).

RMEM includes m=poly(k) registers each of which can store an L-bit string (words) where we assume that L is linear in the security parameter. A typical modern RMEM has L=32 or L=64. We represent the memory as a 1×m array MEM of words, where for i∈{0,1, . . . , m} we denote by MEM[i] the ith word, i.e., the contents of the i-th register. By convention, the address of register MEM[i] is i. We shall denote the size (i.e., number of registers) in a given MEM as |MEM|. Each word in MEM might include an instruction from the set I, or an address in the RMEM, or program data, or combinations of these. For example, in modern memory where the words are 64-bits, a word might contain more than one instruction or a combination of instruction and an address.

The Central Processing Unit (CPU).

The CPU includes a set of registers each of which is also assigned a unique address and can store an L-bit word. Similarly to the notation used for the random access memory MEM, we model these registers as an array REG of words, where we denote by REG[i] the content of the ith register. Note that unlike the RMEM which might include thousands or even millions of registers, a typical CPU has no more than 60 registers. We assume that the total amount of storage of the CPU is linear in the security parameter k.

Some CPU registers have a special purpose whereas others are used for arbitrary operations. Examples of special registers include the input and output register. The input register is used by the CPU in order to receive input from external devices (e.g., the keyboard) and the output register is used to send messages to external devices, e.g., the monitor. For simplicity, we assume that the RAM might only read from its input register i.e., cannot overwrite it, (only the user can write on it via its input device) and that both the input and the output register are of size polynomial in the security parameter k. Another example of special register which we already saw is the program counter pc which stores the location in the memory that the will be read in the next CPU cycle. As already mentioned, unless PC is changed by the CPU via a so-called jump instruction, it is augmented by 1 at the end of each CPU cycle. Finally, the total number of CPU cycles executed from the beginning of the computation is stored on another special register which we refer to as the clock-counter. The state of the CPU at any point is described by a vector including the contents of all CPU registers at that point.

The CPU also includes certain components which allow it to perform operations on its registers and communicate with the RMEM as well as peripheral devices such as the keyboard and the monitor. A detailed description of these components is not necessary in our level of abstraction. The set of all possible operations that a CPU might perform is called the instruction set I. Informally, I might include any efficiently computable transformation on the state of the CPU along with two special commands that allow the CPU to load messages to and from the memory MEM. For the purpose of this description, each instruction is represented as a tuple of the form (opcode, α₁, . . . , αₗ), where opcode is an identifier for the operation/transformation to be executed, and each αᵢ is either an address of a CPU register, or an address of an RMEM location, or a signed integer.

The following are some examples of typical CPU instructions:
(read, i, j) which copies the contents of the ith RMEM location to the jth CPU register, i.e., sets REG[j]:=MEM[i]
(write, j, i) which writes the contents of the jth CPU register into the ith memory location.
(no_op) is the empty operation which instructs the CPU to simply proceed to the next round.
(copy, j, i) which writes the contents of the jth CPU register to the jth CPU register.
(erase, i) which writes 0's on the i CPU register.
(add, i, j) which adds the two register (and stores the result to the second) i.e., it sets REG[j]:=REG[i] REG[i]
(mult, i, j) which multiplies the two register (and stores the result to the second) i.e., it sets REG[j]:=REG[i]+REG[j]
(jump, i) which changes the contents of the program counter PC to equal REG[i]
(jumpif, P, i, j) which of a given Boolean predicate P:{0,1}*→{0,1} checks if P(REG[i])=1 and if so changes contents of the program counter PC to equal REG[i](i.e., implements a conditional jump).

We next establish some useful notation and terminology. A CPU is defined as a pair C=(REG, I) of the vector REG of registers and an instruction set I. We denote a RAM [symbol] with CPU C and RMEM MEM as the pair [symbol] =(C, MEM). The state of a RAM [symbol] at any point in the protocol execution is the vector (REG, MEM) including the current contents of all its CPU and RMEM registers. To allow for asymptotic security definitions where the size of the CPU (i.e., number of its registers) and the size of the memory are polynomial in the security parameter we often consider a family of RAM's, [symbol] ={ [symbol] =(C, { [symbol] , where for each k∈ [symbol] :|MEMₖ|=poly(k). Whenever clear from the context, we refer to such a family as a RAM. Note that all members of a RAM family use a fixed size CPU.

In the following we define the notion of a complete CPU. A CPU is complete (also referred to as universal) if given sufficient (but polynomial) random access memory it can perform any efficient deterministic computation.

Definition 1.

(complete CPU). A CPU C=(REG, I) is complete if for any deterministic polynomial algorithm B and for any polynomial-size input x for B, there exists a RAM [symbol] =(C, MEM), where |MEM|=poly(|x|) such that [symbol] outputs y←B(x) in a polynomial number of rounds.

We at times refer to a RAM (family) with a complete CPU as a complete RAM (family). An example of a complete CPU is one which has three registers, and can, in addition to communicating with its RMEM, compute any Boolean circuit on any two of these registers and store it on the third. Note that emulating the execution of modern software on such a CPU would be very slow; in fact, as mentioned above modern CPUs many more registers and might perform several complicated instructions in a single round.

### 3.2. Software Execution

A program to be executed on a RAM [symbol] =(C, MEM) is described as a vector W=(w₀, . . . , wₙ₋₁)∈({0, 1}^{L})ⁿ of words that might be instructions, addresses, or program data. To avoid confusion, we refer to such a vector including the (binary of a) software and its corresponding data as a programming for [symbol] .

The execution of a program proceeds as follows. The vector W including the program and its data is loaded into the memory MEM. Unless stated otherwise, we assume that W is loaded sequentially on the first n=|W| locations of MEM, i.e., for each j∈{0, . . . , n−1}: wⱼ is written on register MEM[j]. Every location of j of MEM with j≧|W| is filled with (no_op) operations. The user might give input(s) to [symbol] by writing them on its input register in a sequential (aka write once) manner, i.e., a new input is written (appended) next to the last previous input. Without loss of generality, we assume that all CPU registers are filled with zeros at the onset of the computation (and before inputs are given). Once the data are loaded (and, potentially, input has been written on the input register) the RAM starts its execution by fetching the word of the RMEM which the program counter points to, i.e., MEM[pc]. Unless stated otherwise, at the beginning of the computation pc is initiated to 0 (i.e., points to the first memory location). Following that, it executes the program in CPU cycles as described above. Note that we make no “private state” assumption about the CPU and, in particular at the beginning of the computation, all the CPU registers are set to the all-zero word 0^{L} and its first action is to read from the random access memory.

The computation of a RAM typically stops when it reaches a halting state which is specified by setting the value of a special CPU register which we call the halting register. For simplicity, we assume that the halting register stores only a bit which is set to 1 when the RAM reaches a halting state. However, as we are interested in capturing even reactive computation which might generate output and receive inputs several times during the execution, we make the following assumption. If a RAM [symbol] has reached a halting state and some new input is written (appended) in its input register, then [symbol] resumes the computation, i.e., increases the program counter and proceeds to the next CPU cycle. The state of the RAM at the beginning of this new round is identical to its halting state with the only difference that the halting register is reset to zero and the program counter is increased by one.

A property for programmings W which will be useful in our constructions is that it does not try to read or write from a memory location which is “out of the W boundaries”.

Definition 2.

Let [symbol] =(C, MEM) be a RAM and W=(w₁, . . . , wₙ) be a programming which is written on memory locations MEM[i₁], . . . , MEM[iₙ]. We say that W is self-restricted for [symbol] if for any input sequence, an execution of [symbol] initiated with W as above never writes or reads from a location j≠{i₁, . . . , iₙ}.

The definition of self-restricted programming naturally extends to a RAM family [symbol] = [symbol] .

Definition 3.

Let [symbol] ={ [symbol] .={C, ME [symbol] be a RAM family. A programming W is a self-restricted programming for the RAM family [symbol] if for some k∈ [symbol] with k=poly ([W]), W is a self-restricted programming for [symbol] ₖ.

### 3.3. Virus Injection

A virus attacks a RAM by injecting its code on selected locations of the memory RMEM. For simplicity, we assume that the virus can only inject sequences of full words but our constructions can be extended to apply also to viruses whose length (in bits) is not a multiple of the word length L. More formally, an l-word virus is modeled as a tuple virus=(\vec{α}, W)=((α₀, . . . , αₗ₋₁), (w₀, . . . , wₗ₋₁)), where each a, αᵢ∈\vec{α} is a location (address) in the memory and each wᵢ ∈W is a word. The effect of injecting a virus virus into a RAM [symbol] =(C, MEM), is to have for each αᵢ∈\vec{α}, the register MEM[αᵢ] (over)written with wᵢ. We say that the virus is valid for [symbol] if the following properties hold: (1) αᵢ≠αⱼ for every αᵢ, αⱼ∈\vec{α} and (2) αᵢ∈{0, . . . , |MEM|−1}, for every αᵢ∈\vec{α}. Furthermore, we say that virus is non-empty if |\vec{α}|>0.

Note that we do not allow the virus to inject itself on the CPU registers. This is justified by the fact that during the software execution, the CPU communicates only with the RAM and the input/output devices. Importantly, we make no security or privacy assumption, such as tamper-resilience, on the CPU. For example, an “intelligent” virus is allowed to take full control of the CPU, i.e., overwrite all its registers, while it is being executed.

The viruses that we consider in this work are continuous, i.e., the virus injects itself into contiguous locations in the RAM's memory. In this case, the definition of a valid virus can be simplified to a pair virus=(α, W), where W is as above and α∈{1, . . . , |MEM|−|W|} indicates the position in RMEM where the first word of the virus is injected. Nonetheless, our definitions are more liberal and are for arbitrary (not necessarily continuous) viruses. In the following we denote by |virus| the size (also referred to as length) of the virus, namely its number of words (for non-consecutive viruses |virus|=|\vec{α}|).

### 4. Virus Detection Schemes

In this section we formalize our notion of provably secure virus detection. More concretely, we introduce the notion of a virus detection scheme (in short VDS) which demonstrates how to compile a given program (and its data) into a modified program which allows us to detect a virus which is injected as long as it modifies the programming of the RAM. The detection is done via a provable secure challenge-response mechanism. Importantly, the execution of the compiled program is only a small factor slower than the execution of the original program (typically a small constant factor).

### 4.1. VDS Model

Definition 4.

A virus detection scheme (VDS) [symbol] includes four algorithms, i.e., [symbol] =(Compile, Challenge, Response, Verify), defined as follows:
Compile is a randomized algorithm which takes as input the description [symbol] =(C, MEM) of a RAM, a programming W for [symbol] , and a key

$$K {←}^{\$} 𝒦 ,$$

where [symbol] ∈{0,1}^{O(k)} is the key-space, and outputs a secure programming \tilde{W} for a [symbol] =(C, [symbol] ) with the same CPU C and with memory size | [symbol] |=poly (max{k, |MEM|)}); i.e.,

$$\tilde{W} {←}^{\$} Compile ( ℛ , W , K ) .$$

Note that K might be a symmetric-key or a public-key/symmetric-key pair.
Challenge is a randomized algorithm that on input of a key K∈ [symbol] , and a string z∈Inp_{Chal}⊂{0,1}^{poly(k)} outputs a challenge string c∈Out_{Chal}, where Out_{Chal}⊂{0,1}^{poly(k)} denotes the output domain of algorithm Challenge; i.e.

$$c {←}^{\$} Challenge ( x , K ) .$$

Response is a (potentially) randomized algorithm which on input of a string c∈Out_{Chal} and an | [symbol] |-long word-vector \tilde{W} outputs a string y∈Out_{Resp}; where Out_{Resp} ⊂ {0,1}^{poly(k)} denotes the output domain of algorithms Response; i.e.,

$$y {←}^{\$} Response ( c , \tilde{W} ) .$$

Verify is a (potentially) randomized algorithm which on input K∈K, a message z∈Inp_{Chal}, a challenge c∈Out_{Chal} and a response y∈Out_{Resp} outputs a bit b∈{0,1}; i.e.,

$$b {←}^{\$} Verify ( K , z , c , y ) .$$

We say the Verify accepts if b=1.

### 4.2. VDS Security Properties

In the following we specify security properties which a VDS preferably should satisfy. The first property is verification correctness which, intuitively, guarantees that if the RAM has not been attacked, then the reply to the challenge is accepting (except with negligible probability).

Definition 5

(verification correctness). A virus detection scheme V=(Compile, Challenge, Response, Verify) for a RAM family R, is verification-correct iff for every programming W of R the following holds for some negligible function μ,

$$Pr [ \begin{matrix}K {←}^{\$} κ ⋀ \tilde{W} {←}^{\$} Compile ( R , W , K ) ⋀ z {←}^{\$} {Inp}_{Chal} ⋀ c {←}^{\$} Challenge ( z , K ) \\ ⋀ y {←}^{\$} Response ( c , \tilde{W} ) ⋀ Verify ( K , z , c , y ) \neq 1\end{matrix} ] \leq μ ( k )$$

The probability in the above definition is taken over the random coins of all involved algorithms and the coins for sampling the key.

The second desired property of a VDS is compilation correctness, which intuitively ensures that the compiled code \tilde{W} encodes the same program as the original code W. This means that on the same input(s) from the user the following properties hold: (1) R, produces the same output sequence, and (2) there exists an efficient transformation which maps executions of R programmed with \tilde{W} onto executions of R programmed with W such that the contents of the memory MEM at any point of the execution of R with programming \tilde{W}, are efficiently mapped to contents of MEM at a corresponding point in the execution of R, with programming W. This latter property will be useful in reality, where the computation also modifies program data which need to be returned to the hard drive to be used by another application.

Note that an execution of \tilde{W} might terminate (and/or generate outputs) after a different number of CPU cycles than an execution of W. The reason is that the compiler will typically spread out the execution of each W-instruction over several CPU rounds. Notwithstanding, we require that these extra rounds are polynomial in the number of rounds that the original program W would need to produce outputs and/or terminate. In the following, for a RAM R.=((REG, I), MEM) and for a p∈ [symbol] , we denote by RMEM(W, p, \vec{x}=(x₁, . . . , xi)) the state of MEM (i.e., the contents of MEM) at the end of the p-th CPU cycle when executed on inputs x₁, . . . , xᵢ and programming W; we also denote the set of all possible memory states of R, by Σ_{R}_{_{MEM}}. Moreover, we denote by Rₒᵤₜ(W, p, \vec{x}=(x₁ . . . , xᵢ)) the first output generated by R, (i.e., the first string written on the CPU's output register) after round p.

Definition 6

(Q-bounded emulation). Let Q: [symbol] → [symbol] be an efficiently computable monotonically non-decreasing function, and for a RAM [symbol] =(C, MEM) let W be a programming for [symbol] . We say that a programming \tilde{W} for RAM [symbol] =(C, [symbol] ) with | [symbol] |=poly (MEM) is a Q-bounded sound emulation of W if there exists an efficiently computable function

[symbol]

: [symbol] → [symbol] such that for every p∈ [symbol] and every sequence \vec{x} of inputs the following two properties holds for a negligible function μ:

[symbol]

ₒᵤₜ(\tilde{W},Q(ρ),\vec{x}))= [symbol] ₒᵤₜ(W,ρ,\vec{x}), and

[symbol]

( [symbol] _{MEM}(\tilde{W},Q(ρ),\vec{x}))= [symbol] _{MEM}(W,ρ,\vec{x})

Definition 7

(compilation correctness). A VDS [symbol] =(Compile, Challenge, Response, Verify) for the RAM [symbol] is compilation correct if for any programming W of [symbol] there is a known polynomially computable function Q: [symbol] → [symbol] such that the compiled programming

$$\tilde{W} {←}^{\$} Compile ( ℛ , W , K )$$

is a Q-bounded emulation of W except with negligible probability. As before the probability is taken over the random coins for choosing the key K and for executing algorithm Compile.

In an application of a VDS, the user (who executes a compiled program on his computer) should only be expected to input the challenge (e.g., as a special input) at a point of his choice and check that the reply verifies according to the predicate Verify. Thus, another desired property of a VDS is self-responsiveness, which requires that the secured programming \tilde{W} includes the code which can compute the response algorithm Response. On a high-level, the requirement here is that upon receiving a special input message x′=(check, c) the next output of the RAM equals the output of Response on input c with overwhelming probability.

Definition 8

(self-responsiveness). A VDS [symbol] =(Compile, Challenge, Response, Verify) for a RAM [symbol] is self-responsive if there exist efficiently computable monotonically non-decreasing function Q: [symbol] → [symbol] such that for every programming W of [symbol] and every sequence of inputs \vec{x} with (check, c)∈\vec{x} and c∈Inp_{chal}, assuming the input (check, c) is written on [symbol] 's input register at round ρ, the following property holds for some negligible function μ

$$Pr [ \begin{matrix}\begin{matrix}K {←}^{\$} K \tilde{W} {←}^{\$} Compile ( ℛ , W , K ) z {←}^{\$} \\ {Inp}_{Chal} c {←}^{\$} Challenge ( z , K )\end{matrix} \\ 𝓎 {←}^{\$} Response ( c , \tilde{W} ) 𝓎 \neq {\tilde{ℛ}}_{out} ( \tilde{W} , Q ( ρ ) , \vec{x} )\end{matrix} ] \leq μ ( k )$$

where [symbol] =(C [symbol] ) with ┌ [symbol] ┐=poly ┌MEM┐

[symbol]

The aforementioned properties, specify the behavior of software protected by a VDS when it is not infected by a virus. Last but not least, we also desire detection accuracy which states that if some non-empty malware is injected onto the RAM, then it is detected with high probability. This is one of the most challenging properties to ensure and is the heart of any VDS. In the following we specify this property by means of a security game between an adversary Adv who aims to inject a virus on a RAM, and a challenger Ch who aims to detect it. Informally, the security definition requires that Adv cannot inject a virus without being detected, except with sufficiently low probability.

### 4.3 Modelling Virus Vulnerability

At a high-level, the security game, denoted by [symbol] , proceeds as follows. The challenger Ch picks a uniformly random key K and compiles a programming W of a RAM [symbol] into a new programming [symbol] by invocation of algorithm Compile. Ch then emulates an execution of [symbol] on [symbol] , i.e., emulates its CPU cycles and stores its entire state at any given point. The adversary is allowed to inject a virus of his choice on any location in the memory MEM. Eventually, the challenger executes the (virus) detection procedure. It computes a challenge c by invocation of algorithm Challenge ( [symbol] , K), and then feeds input [symbol] c) to the emulated RAM and lets it compute the response y.

To capture worst case attacks scenarios, we allow the adversary to inject his virus at any point during the RAM emulation and make no assumption as to how many rounds the RAM executes after the virus has been injected. Although this might seem redundant given the “closed-system” assumption on the RAM, i.e., that it only loads data on MEM from external devices at the beginning of the execution, real-world software might indeed load more data while it executes. More concretely, we allow the adversary to specify the number ρₚᵣₑ of rounds to be executed before the detection process kicks in, and the index ρₐₜₜ of the round in which Adv wants the virus to be injected on the memory. Furthermore, we make no assumptions on how much information the adversary holds on the original programming W or on the inputs/outputs of [symbol] , by assuming that Adv knows W and can decide/see the entire sequence of inputs/outputs.

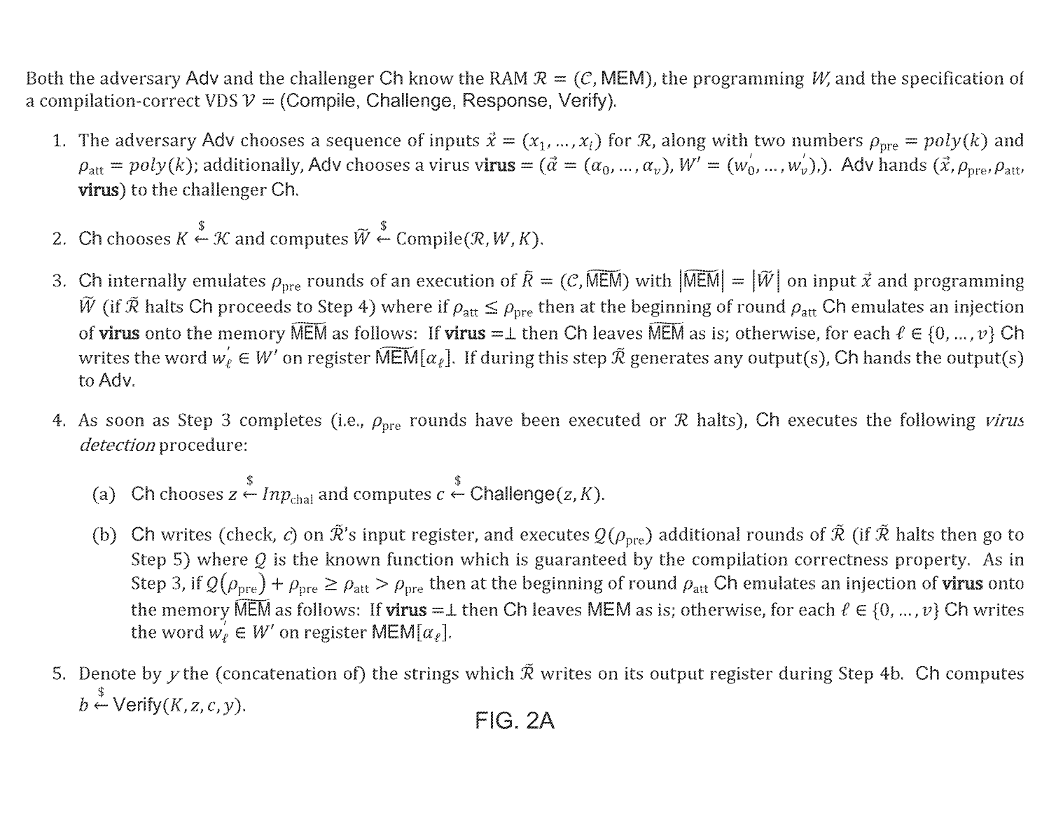

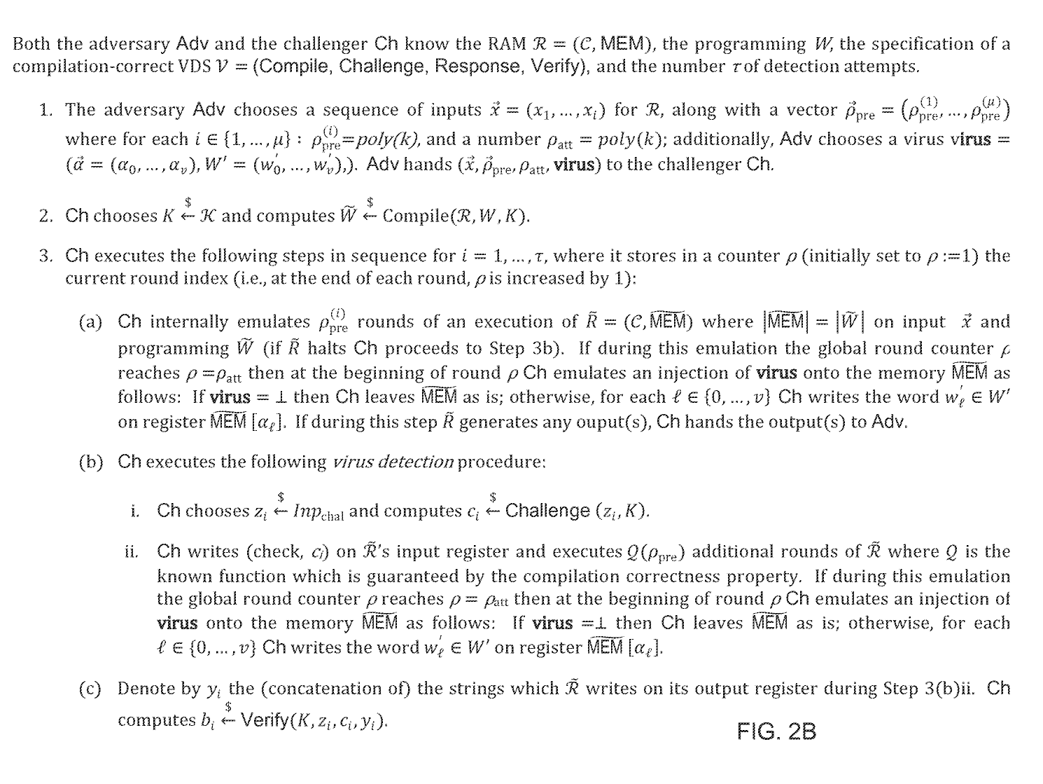

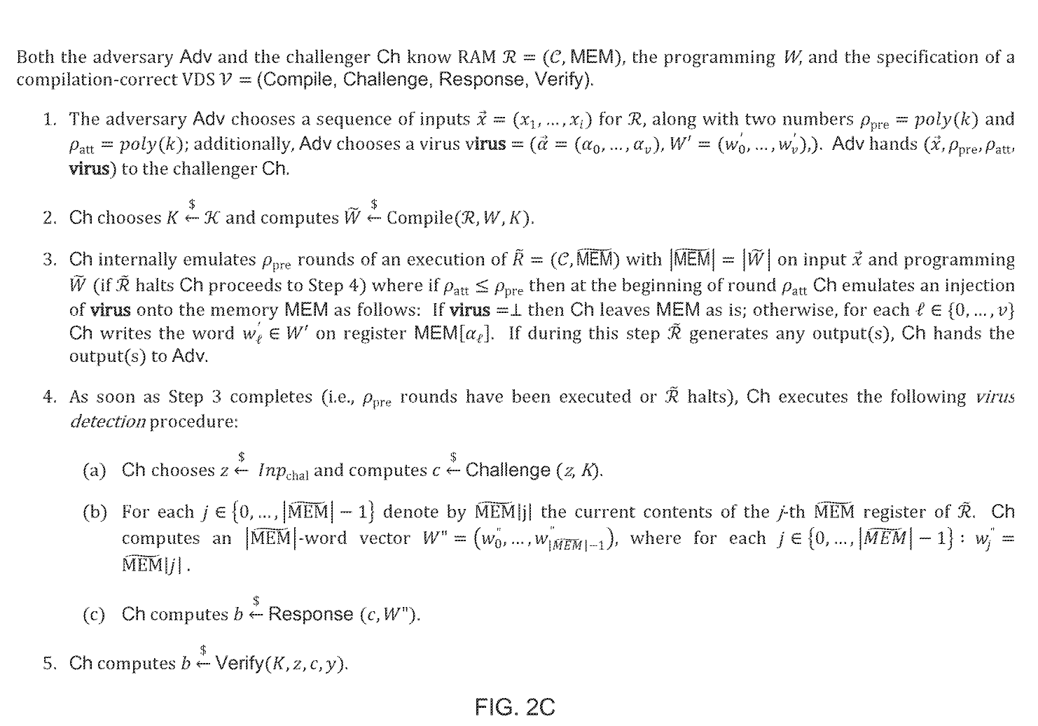

The formal description of the security game [symbol] is shown in FIG. 2A. Both Adv and Ch know the specification [symbol] of the RAM under attack as well as the VDS V and the programming W. For simplicity we describe the game for the case where the adversary injects a virus only once, but our treatment can be extended to repeated injections. We present the game for self-responsive VDSs. The simpler (but less secure) notion of non-self-responsive VDS's can be obtained by modifying Step 4b in FIG. 2A so that the challenger is evaluating Response himself, i.e., without invoking the RAM. We return to this relaxation in Section 5.1 below as building such a weaker VDS turns out to be useful for our construction of self-responsive VDS.

Definition 9A.

We say that a virus detection scheme [symbol] =(Compile,Challenge,Response,Verify) is secure for RAM family [symbol] if it satisfies the following properties for any programming W of [symbol] :

1. [symbol] is verification correct, compilation correct, and self-responsive

2. For any polynomial adversary Adv in the game [symbol] who injects a valid non-empty virus:

Pr[b=1]≦μ(k),

where μ is some negligible function, and the probability is taken over the random coins of Adv and Ch. Note that the random coins of Ch include the coins used by the executed algorithms of the VDS.

In our constructions we restrict our statements to certain class of programming that satisfy some desirable properties making the compilation easier. We will then say that the corresponding VDS is secure for the given class of programmings.

The Repeated Detection Game

The above security definition requires that the adversary is caught even when he injects its virus while the RAM is executing the Response algorithm. Indeed, this is captured by the check in Step 4b. In the following we describe a relaxed security game which also provides a useful guarantee for practical purposes. In this game the virus detection (challenge/response) procedure is executed multiple times periodically (on the same compiled programming). The requirement is that if the adversary injects its virus to the RAM at round p, then he will be caught by the first invocation of the virus detection procedure which starts after round p. Note that all executions use the same compiled RAM program and therefore the same key K To obtain a worst case security definition we allow the adversary to even define the exact rounds in which the detection procedure will be invoked. In most practical applications, however, it will be the user that specifies these intervals. The corresponding security game [symbol] which involves τ executions of the detections procedure is described in FIG. 2B. The security definition is similar to Definition 9A but requires that any virus that is injected in the RAM will be caught in the first virus detection attempt performed after the injection.

In the following, we refer to the ith execution of Step 3b in the repeated detection attack game [symbol] (FIG. 2B) as the ith virus detection attempt. The corresponding security definitions state that any virus that is injected in the RAM will be caught in the next virus detection attempt.

Definition 9B

(Security in the Repeated Detection Game). We say that a virus detection scheme [symbol] is secure for a RAM family R, in the repeated detection model if it satisfies the following properties for any programming W of R:

1. [symbol] is verification correct, compilation correct, and self-responsive.

2. For any τ∈ [symbol] ⁺ and any polynomial adversary Adv in the repeated detection attack game τ [symbol] who injects a valid non-empty virus before the ith virus detection attempt,

Pr[bᵢ=1]≦μ(k),

where μ is some negligible function.

### 5. Some VDS Examples

In this section we provide some examples of VDSs. We begin with examples which are secure assuming the virus is not too short, i.e., assuming its length is linear in the security parameter or, stated differently, assuming that the virus has a constant number of words. Recall that in all our constructions, we also assume that the virus is continuous, This includes most malware in reality, as viruses are usually several words long. Nonetheless, in Section 5.4, we even show how to get rid of this length restriction.

Our construction for VDSs secure against non-short viruses proceeds in three steps. In a first step we show how to construct a VDS [symbol] ₁ which achieves a weaker notion of security that, roughly, does not have self-responsiveness. In a second step, we show how to transform [symbol] ₁ into a VDS [symbol] ₂ which is secure in the repeated detection game. Finally, in a third step we show how to transform [symbol] ₂ into a VDS [symbol] ₃ which is secure in the standard detection game. VDSs [symbol] ₁ and [symbol] ₂ are not described only as steps towards building [symbol] ₃, but may also be useful in applications where their corresponding (weaker) security guarantees are satisfactory. In a final extension, we extend the VDS to one that is secure against arbitrarily short viruses.

5.1 A VDS without Self-Responsiveness

In this section we describe the VDS [symbol] ₁=(Compiler₁, Challenge₁, Response₁, Verify₁) which has security without self-responsiveness. More concretely, the corresponding attack-game [symbol] is derived from the standard attack-game [symbol] by modifying the detection procedure so that in Step 4b of the standard attack game [symbol] (FIG. 2A), instead of invoking the RAM [symbol] on the compiled programming \tilde{W} and input (check, c) to compute y=Response(c, \tilde{W}), the challenger evaluate

$$y {←}^{\$} Response ( c , \tilde{W} )$$

himself. For completeness, we have included the detailed game description [symbol] as FIG. 2C.

Definition 10.

(Security without self-responsiveness). We say that a virus detection scheme [symbol] is secure without self-responsiveness for a RAM family [symbol] it satisfies the following properties for any programming W of 7Z:

1. [symbol] is verification correct and compilation correct

2. For any polynomial adversary Adv in the virus detection attack game without self-responsiveness [symbol] (FIG. 2C) who injects a valid non-empty virus

Pr[b=1]≦μ(k).

where μ is some negligible function.

At a high level, the idea of our construction is as follows. The algorithm Compile₁ chooses a key K uniformly at random, computes an additive sharing of [symbol] K [symbol] and interleaves a different share of [symbol] K [symbol] between every two words in the original programming. More precisely. Compile compiles a programming W for a RAM (family) [symbol] into a new programming \tilde{W} [symbol] constructed as follows: Between any two consecutive words wᵢ and wᵢ₊₁ of W the compiler interleaves a uniformly chosen k-bit string

$${K}^{i , i + 1} = {K}_{1}^{i , i + 1} ‖ … ‖ {K}_{\frac{k}{L}}^{i , i + 1} ,$$

where each Kⱼ^{i,i+1}∈{0, 1}^{L}. In the last k bits of the compiled programming (i.e., after the last word w_{|W|-1}) the string K^{last}=K⊕⊕ᵢ₌₀^{|W|-2}K^{i,i+1} is written.

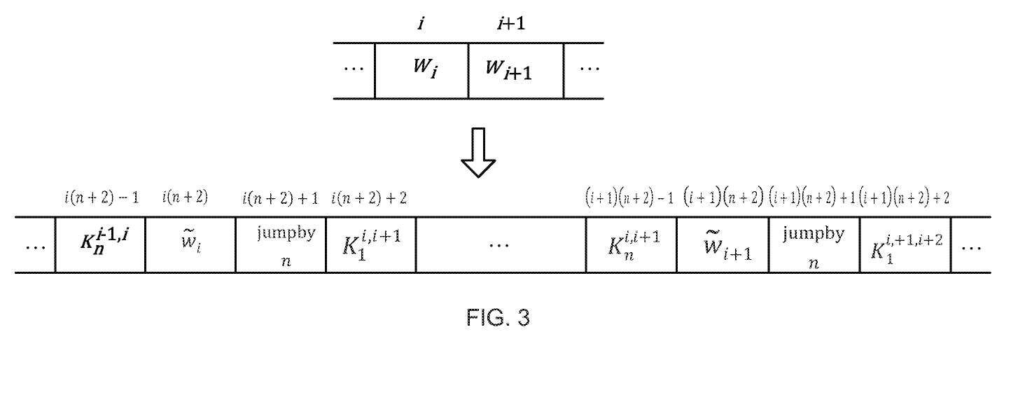

To ensure that the compiled programming \tilde{W} executes the same computation as W we need to ensure that while being executed it “jumps over” the locations where key shares are stored (as the key shares are only for use in the detection procedure). For this purpose, we do the following modification. After each word wⱼ of the original program we put a (jump, α) instruction where α is the position in the compiled programming that wⱼ₊₁ has been moved to. The transformation from W to \tilde{W} is shown in FIG. 3. Similarly, we modify any jump instructions of the original programming W to point to the correct locations in \tilde{W}. Depending on the instruction set and the actual programming W this could be done in different ways. For simplicity, here we will assume that the programming W we are compiling has the following properties:

1. W is self-restricted for the given RAM (family) [symbol] .

2. The only type of instructions in W which change the program flow (i.e., modify the program counter) are of the form (jumpto, z), (jumpto_if, •,•,z), (jumpby, z), and (jumpby_if, •,•,z), where z∈ [symbol] is a fixed integer with |W|−1≦z>0. The (conditional) jump commands have the following effect:
(jumpby, z) updates the program counter as pc=pc+z. Note that this means that in the next cycle the word at position in pc+z+1 of RMEM will be fetched, as at the beginning of each round ρ>1 the program counter is always increased by one.
(jumpby_if, P, i, z) executes (jumpby, z) if P(REG|i|)=1, where P:{0,1}^{L}→{0,1} is a Boolean predicate and i∈{0, . . . ,|REG|−1}. Note that the predicate makes jumps only conditioned on words written on CPU registers and not on the random access memory.

[symbol]

3. For any input sequence, an execution of Win RAM [symbol] does not write any (new) instructions to the memory MEM and does not write on locations where instructions other than no_op are written. We point out that W is allowed to over-write program data but is not allowed to insert new instructions to the memory. This will be useful for ensuring that our compiled code jumps to the correct memory locations.

4. The only instructions that access the random access memory RMEM are (read, i, j), (write, j, i) as described above, and the built-in load command that is executed at the beginning of each CPU cycle and loads the contents of MEM[pc] to a special CPU register. All other instructions define operations on values of the CPU registers.

We refer to a programming W which satisfies the above conditions as a non-self-modifying structured programming for [symbol] . Without loss of generality, we shall allow that any considered RAM has the above instructions as part of its CPU instruction set I. Observe, that the above specification is sufficient for any structured program, i.e., a program which does not use “goto” commands but might use while and for loops. As a fact, writing structured programs is considered a good practice and most programmers avoid writing self-modifying code as it can be a source of bugs. Furthermore, classical results in programming languages imply that any program can be compiled to a structured program with a low complexity overhead.

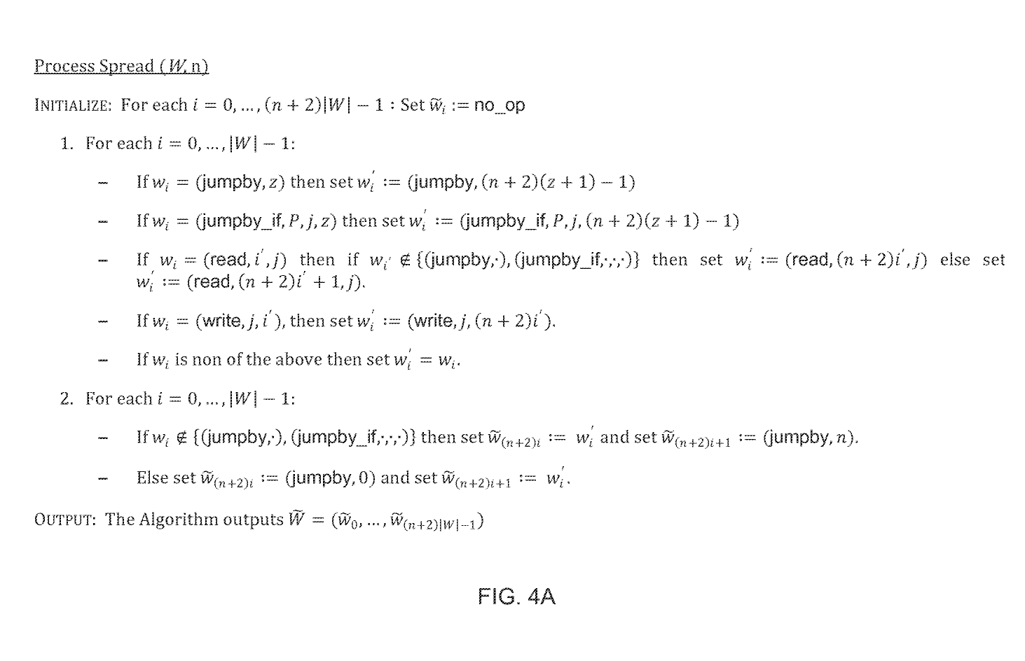

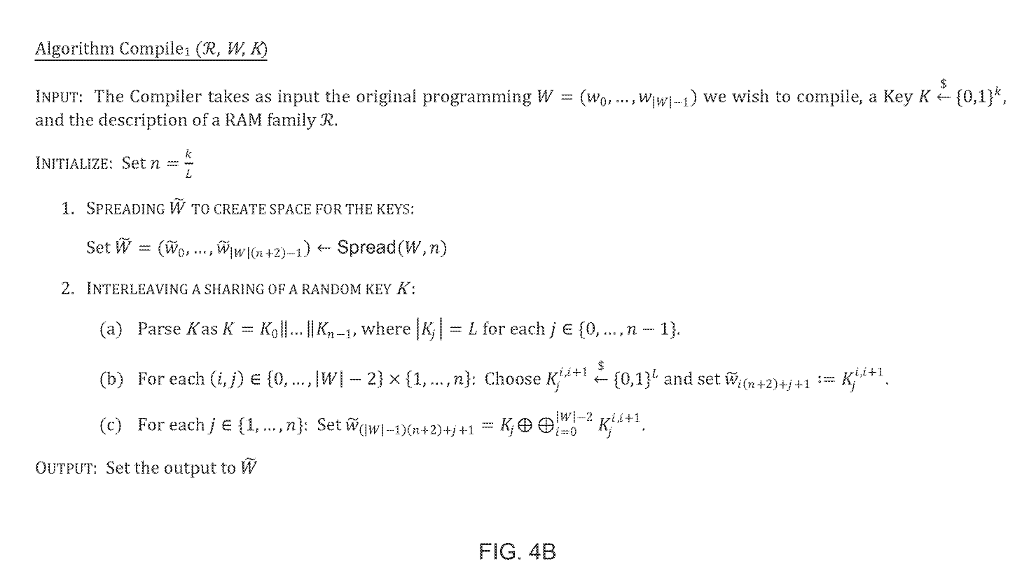

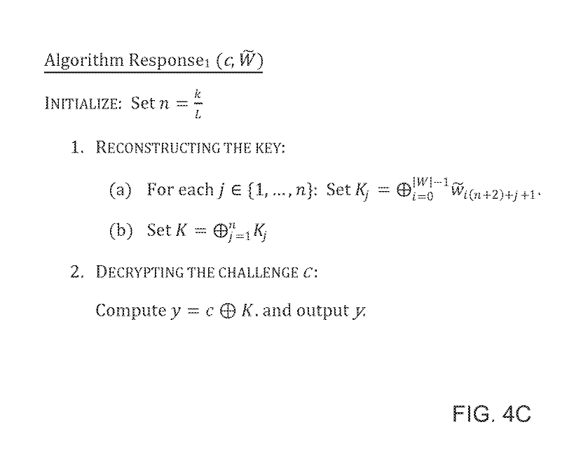

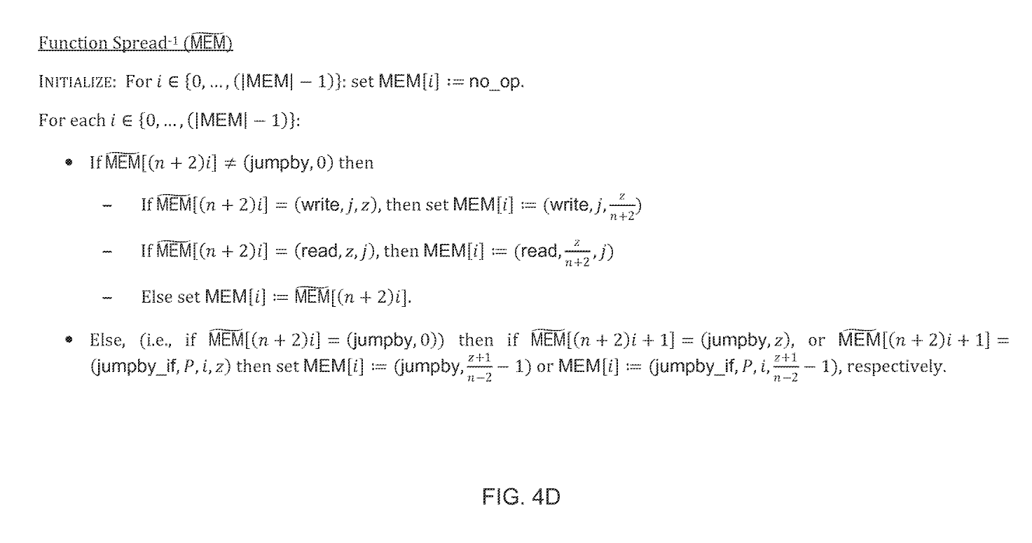

In the following we include a formal description of our compiler. For completeness, we first describe a process, called Spread (see FIG. 4A), which spreads a structured programming to allow for enough space between the words to fit the key shares and add the extra “jump” instructions to preserve the right program flow. We then describe our compiler Compile₁ (see FIG. 4B) that uses the Spread-out programming and replaces the no_op's with appropriate key shares. Spread is only an example of moving things around for creating space for the key shares. More sophisticated techniques using ideas from the security and programming languages literature can also be used.

Referring to FIG. 4A, for any given n∈ [symbol] , the process Spread compiles a structured programming W into one which leaves n empty memory locations (filled with no_op instructions) between any two words of W and implements the same computation as W. Informally, Spread compiles W so that a RAM initiated with \tilde{W} always executes two rounds for emulating each round of a RAM initiated with W, i.e., one round for the corresponding operation of W and one extra round for the jump to the position of the next operation of W. To ensure that this one-to-two-round mapping is preserved throughout the execution Spread writes jump only on words \tilde{w}ᵢ with i=1 mod n. Thus, if the ith word of the programming W we are compiling was already a jump operation, then Spread replaces it with a (jump, 0) instruction (whose effect is the same as a no_op instruction) followed by the appropriately modified jump operation which points to the position of the next W word.

The following proven lemma states the properties we desire from Spread.

Lemma 1.

Let W be a self-restricted, non-self-modifying structured programming for a complete RAM [symbol] =(C, MEM). Then for any n∈ [symbol] , the algorithm Spread(W, n) outputs a self-restricted non-self-modifying structured programming \tilde{W}=(\tilde{w}₁, . . . , \tilde{w}ₘ) for RAM [symbol] =(c, [symbol] ) with | [symbol] |=n|MEM| satisfying the following properties:

1. \tilde{W} is a Q-bounded emulation of W, where Q(φ=2ρ.

2. An execution of \tilde{W} on RAM [symbol] never accesses (reads or writes) memory locations [symbol] [i] with i(mod n+2)∉{0,1}.

Given the process Spread we can now provide the detailed description of this example compiler Compile₁ (see FIG. 4B). The compiler translates a self-restricted non-self-modifying structured programming W for a RAM [symbol] =(C, MEM) into a programming \tilde{W} of a RAM [symbol] =(C, [symbol] ), with | [symbol] |=(k+2)|MEM|. Recall that we assume that k is a multiple of L.

To complete the description of VDS VI we describe the remaining three algorithms Challenge₁, Response₁ and Verify₁. The algorithm Challenge₁, chooses random string x, ∈{0, 1}^{k}, and computes the challenge as an encryption of x with key K; i.e., c←Challenge(x, K)=Enc_{K}(x). For achieving security without self-responsiveness, we can take Enc to be the one-time pad, i.e., EnC_{K}(x)=x⊕K. The corresponding algorithm Response₁ works as follows. On input of the challenge c=Enc_{K} (r) and the compiled programming \tilde{W}, it reconstructs the sharing of K by summing up all its shares as retrieved from \tilde{W} and outputs a decryption of the challenge under the reconstructed key, i.e., outputs y=c⊕K (see FIG. 4C). The corresponding verification algorithm Verify, simply verifies that y=x.

Intuitively the security of the above scheme follows from the fact that an adversary who injects a linear virus as a single block on the RAM's memory will have to overwrite a linear number of bits of some key share which will make it infeasible to correctly decrypt the challenge and thus pass the VDS check. Note that here we use a non-standard property of the additive sharing which states that an adversary who erases l bits of any share, has probability 2^{l-k} of recovering the secret even knowing all the remaining sharing information.

Theorem 1.

Assuming [symbol] is a complete RAM family, if the adversary injects a virus virus with |virus|≧3 on consecutive locations of the random access memory, the VDS [symbol] ₁ is secure for [symbol] without self-responsiveness with respect to the class of all non-self-modifying structured programmings.

Proof.

We prove each of the properties of Definition 10 separately, namely, verification correctness, compilation correctness, and security in the attack game without self-responsiveness [symbol] (FIG. 2C).

Compilation Correctness:

This property following immediately from Lemma 1 which ensures that Definition 7 is satisfied for Q(p)=2ρ and for the function τ computed by Spread⁻¹ (see FIG. 4D).

Verification Correctness:

Lemma 1 ensures that the execution of the compiled programming \tilde{W} never accesses the key shares. Thus the reconstruction algorithm will succeed in reconstructing the correct key; hence verification correctness of [symbol] ₁ follows from the correctness of decryption of the one-time pad cipher.

Security in [symbol] :

Let c be the challenge as generated by algorithm Challenge₁. Any adversary Adv that passes the verification test with probability ρ can be used by an adversary Adv′ to break the security of one-time pad encryption. More precisely, consider the following game capturing one-time pad encryption with key-leakage between adversary Adv′ and a challenger Ch′:
Ch′ generates a uniform one-time pad key

$$K = {K}_{1} ‖ … ‖ {K}_{n} {←}^{\$} {\{ 0 , 1 \}}^{k} ,$$

where each Kⱼ∈{0,1}^{L}, chooses a uniformly random plaintext

$$x = {←}^{\$} {\{ 0 , 1 \}}^{k} ,$$

computes y=x⊕K, and sends it to Adv′.
Adv′ sends Ch′ a non-empty set I∪{1, . . . , k} of indices and for each i⊂I receives Kᵢ from Ch′.
Adv′ outputs a string x′ and wins iff x=x′.

It follows from the perfect privacy of the one-time pad that the probability that the adversary wins in the above game is at most p=2^{L|I|} which is negligible, since I is non-empty and L is linear in k. In the following we show that if there exists an adversary Adv that wins in the game [symbol] with noticeable probability, then there exists an adversary Adv′ which wins the above one-time pad with leakage game also with noticeable probability which yields a contradiction.

Adversary Adv′ works as follows. It received from its challenger Ch′ the challenge ciphertext y and initiates with Adv an execution of the game [symbol] where he plays the role of the challenger Ch as follows. Upon receiving from Adv′ the virus virus=(α, (w₁′, . . . , w_{ν}′)) (recall that we consider a continuous virus which needs only to give the location α where the first word will be injected) Adv′ uses it to find a location of a key share which would be overwritten by virus in an execution of the gam [symbol] . In particular, let i*=min_{i∈{α, . . . , α|ν}}{i|i∉{0,1} (mod n)} and let in iₙ*:=i* mod n. Adv′ sends its challenger Ch the set I={iₙ*} and receives the key-words

$${K}_{1} , … , {K}_{{i}_{n}^{*} - 1} , {K}_{{i}_{n}^{*} - 1} , … , {K}_{n} . Adv sets {\tilde{K}}_{{i}_{n}^{*}} = {0}^{L} and sets$$

$$K = {K}_{1} ‖ … ‖ {K}_{{i}_{n}^{*} - 1} , ‖ {\tilde{K}}_{{i}_{n}^{*}} ‖ {K}_{{i}_{n}^{*} - 1} , ‖ … ‖ {K}_{n} . {Adv}^{′}$$

emulates the execution of Ch′ with the inputs received by Adv, computes the response y′ from Step 4c, and outputs x′=y+y′.

We next argue that if Adv succeeds in his attack with probability ρ then Adv′ also succeeds with probability at least ρ. To this direction, consider the hybrid setting where \tilde{K}_{i*}_{ₙ}=K_{i*}_{ₙ}, i.e, [symbol] _{od}=SK It is easy to verify that the success probability of Adv in this hybrid experiment is identical with the corresponding probability to our original experiment described above. Indeed, until the virus is injected, the key shares are not accessed. Thus Adv overwrites the value of at lest one share of K_{i*}_{ₙ} obliviously of the actual value of \tilde{K}_{i*}_{ₙ}. However, as the sharing is additive, this (overwritten) share acts as a perfect blinding for \tilde{K}_{i*}_{ₙ} and therefore after the injection the distribution of the memory [symbol] in the two hybrids is identical. Hence, the success probability of Adv is also the same in the two experiments. Thus, if Adv′ succeeds in outputting x such that x=y⊕K in the hybrid with probability ρ, he will also succeed in the original experiment with the same probability, and therefore in this case Adv′ wins with probability ρ.

5.2 A VDS with Self-Responsiveness

Our next step is to modify [symbol] ₁ so that it is secure (with self-responsiveness) in the repeated detection. τ [symbol] , where [symbol] has a complete CPU C. Note that the algorithm Response₁ above is deterministic and thus, by definition, can be simulated on such a RAM [symbol] . Towards this direction, prior to applying the above compilation strategy we extend the given sound programming W for RAM [symbol] =(C, [symbol] ) to also implement a corresponding response algorithm. In particular, given any (deterministic) response algorithm Response we can embed to W a programming W_{Resp} with the following property: W_{Resp} is a self-restricted programming for [symbol] =(C, [symbol] ) which computes Response (i.e., on input some (\tilde{W}, c). W_{Resp} computes y=Response (\tilde{W}, c) and writes it on its output register).

Embedding W_{Resp} to W.

The above embedding is done by appending W_{Resp} at the end of W. As long as both W and W_{Resp} are self-restricted, we can be sure that the execution of the one does not modify the part in RMEM where the other is stored. However, to achieve a self-responsive VDS we use a “threading” mechanism which enforces that upon receiving a (check, c) input, the RAM interrupts its execution of Wand jumps to an execution of W_{Resp}. As soon as the execution of W_{Resp} completes, the RAM should continue executing W from where it left off. We point out that modern architectures have several methods for implementing such a multi-thread computation. For completeness, in the following we describe a process that implements the above embedding in a single processor CPU. The process adds a piece of code executing the following computation between any two instructions in W (or alternatively, adds this code on a fixed location and puts a jump pointing to it between any two W words):

The code checks whether the last string written on the input register is of the form (check, c) for some c∈{0, 1}^{k}. If this is not the case it does nothing; otherwise:

1. It stores the entire state of the CPU on the first non-used portion of the memory MEM.

2. It jumps to the part of the memory where W_{Resp} is stored (hence the next step is to execute the response procedure).

3. Once [symbol] finishes executing W_{Resp}, restore the CPU (except input and output registers) to its state before the execution of W_{Resp} by copying back the state as saved to MEM in Step 1 above.

As the CPU C is complete, there exists a programming W_{check} implementing the above embedding procedure which does the conditional thread-switching between W and W_{Resp}. In the following we denote by Emb(W, W_{Resp}) the programming for [symbol] ,=(C, MEM) which computes W with W_{Resp} embedded to it using W_{check} as described above.

It might seem like the new programming Emb(W, W_{Resp}) takes care of the self-responsiveness issue but this is not the case, as applying the compiler Compile₁ from the previous section to Emb(W, W_{Resp}) does not yield a secure VDS in the repeated detection model. Informally, the reason is that the resulting scheme only detects attacks (virus injections) that occur outside the execution of the Response code W_{Resp}. In more detail, a possible adversarial strategy is to inject the virus while the RAM is executing the Response algorithm, and in particular as soon as the key K has been reconstructed on the CPU and is about to be used to decrypt the challenge. By attacking at that exact point, the adversary might be able to inject an “intelligent” virus onto MEM while the key is still in the CPU, restore the key back to the memory and uses it to pass the current as well as all future virus detection attempts.

To protect against the above attack we use the following technical trick. Instead of using a single key K of length k we use a 2k-bit key K which is parsed as two k-bit keys K_{od} and Kₑᵥ via the following transformation. Let

$$K = {x}_{1} ‖ … ‖ {x}_{\frac{2 k}{L}} ,$$

where each xᵢ is a word (i.e., an L-bit string). W log we assume that k=Lq for some q. Then K_{od} is a concatenation of the odd-indexed words, i.e., xᵢ's with i=1 mod 2, and Kₑᵥ is a concatenation of the even indexed words. Now the challenge algorithm outputs a double encryption of [symbol] with keys K_{od} and Kₑᵥ, i.e., c=Enc_{K}_{_{od}}(Enc_{K}_{ₑᵥ}(z)).

In order to decrypt, the response algorithm does the following. First it reconstructs K_{od} by XOR-ing the appropriate shares, and uses it to decrypt c, thus computing EncKₑᵥ(z). Subsequently, it erases K_{od} from the CPU register (the standard way for doing so it by filling the register where K_{od} is stored with 0's) and after the erasure completes, it starts reconstructing Kₑᵥ and uses it (as above) to decrypt EncKₑᵥ(z) and output y=z.

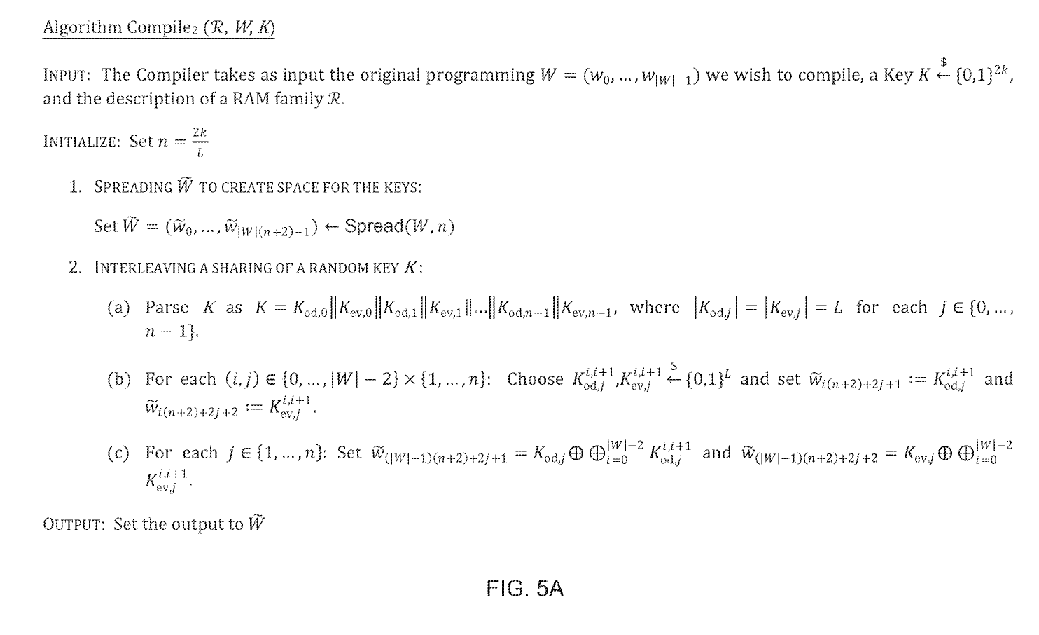

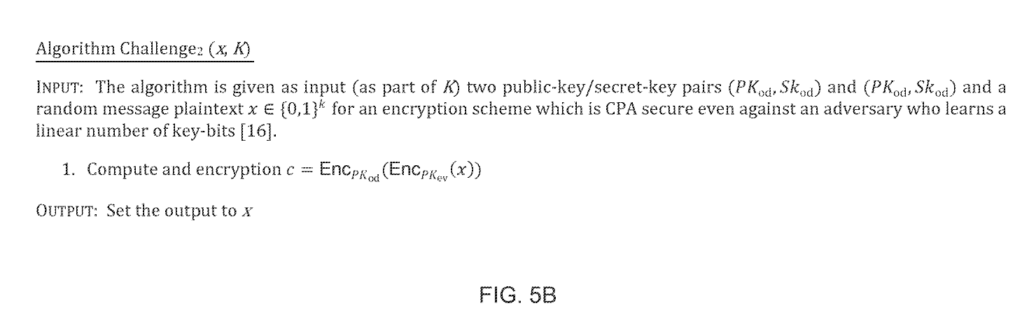

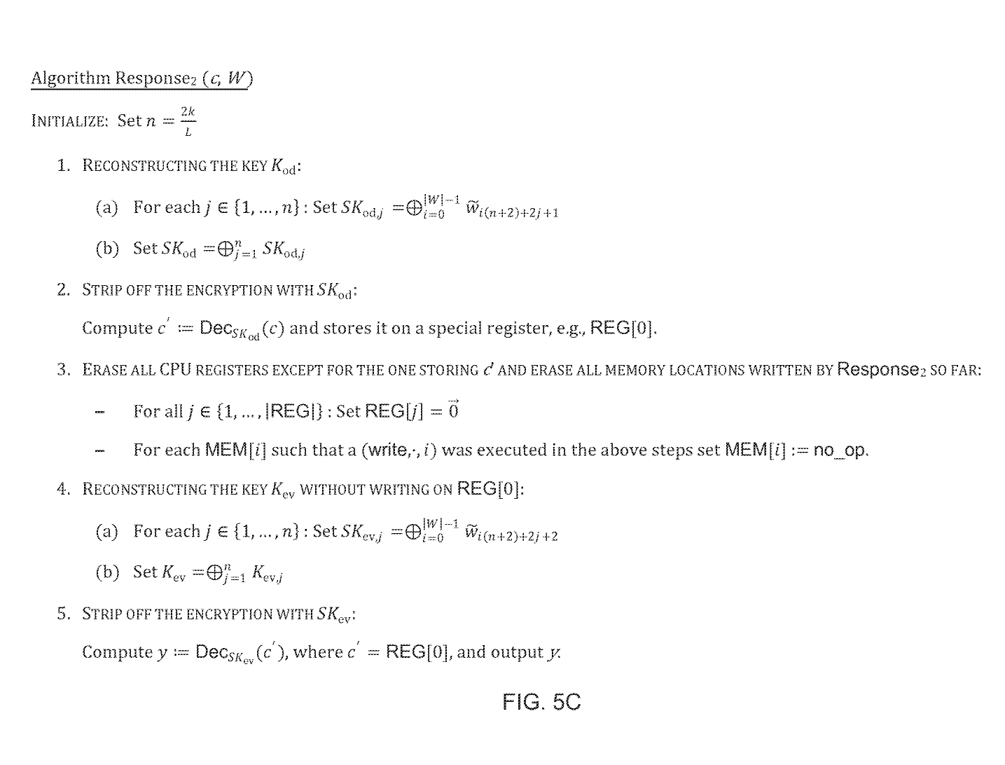

Intuitively, the reason why the above idea protects against an adversary attacking even during a detection-procedure execution in the repeated detection game is that in order to correctly answer the challenge, the virus needs both K_{od} and Kₑᵥ. However, the keys are never simultaneously written in the CPU. Thus if the adversary injects the virus before K_{od} is erased and overwrites l bits of K then he will overwrite l/2 bits from a share of Kₑᵥ (which at that point exists only in the memory). Thus he will not be able to decrypt the challenge. Otherwise, if the adversary injects the virus after K_{od} has been erased from the CPU, then he will overwrite l/2 bits from a share of K_{od}. In this case he will successfully pass this detection attempt, but will fail the next detection attempt. The detailed description of the compiler Compile₂ is given in FIG. 5A.

It might seem as if we are done but this is again not the case, because the above argument cannot work if we instantiate Enc() with one-time-pad encryption as in the previous section. To see why, assume that we use c=z⊕K₁⊕K₂. Because the input register is read-only (for the RAM) once c is given it cannot be erased. Furthermore, from c and y= [symbol] (which is the output of Response) one can recover K_{od}⊕Kₑᵥ:=c⊕y. Now if the adversary injects its virus after y is computed but while Kₑᵥ is still on the CPU's register he can easily recover both K_{od} and Kₑᵥ and answer all future challenges in an acceptance manner. Thus we cannot use the one-time pad encryption as in the VDS [symbol] ₁. In fact, we cannot even use a standard CCA2 secure cipher for Enc(•) as the virus will have access to a big part of the private key and standard CCA2 encryption does not account for that (recall that we only require the virus to overwrite a portion of a key share). Therefore we make use of a leakage resilient encryption scheme which is secure as long as the adversary's probability of guessing the key even given the leakage is negligible. A (public-key) encryption scheme satisfying the above property (with CPA security) was suggested in Yevgeniy Dodis, Shafi Goldwasser, Yael Tauman Kalai, Chris Peikert, and Vinod Vaikuntanathan. Public-key encryption schemes with auxiliary inputs, in Daniele Micciancio, editor, TCC 2010, volume 5978 of LNCS, pages 361-381, Zurich, Switzerland, Feb. 9-11, 2010. Springer, Berlin, Germany [Dodis], which is incorporated herein by reference. We point out that the compiler Compile₂ will only use the secret key (i.e., the secret key plays the role of K in FIG. 5A) and ignores the public key. We refer to the corresponding challenge, response, and detection algorithms instantiated with such a leakage resilient double encryption scheme as Challenge₂ and Response₂, respectively.

For completeness, we describe Challenge 2 in FIG. 5B. We need however to be careful in the design of Response₂. It is important for the security of Response₂ that (1) it does not modify memory (RMEM) locations where key shares are written (as otherwise it will not be possible to answer any future detection attempt) and (2) that is does not copy key shares on other memory locations (as this will ensure that the key shares that the virus overwrites are not recoverable). Therefore we suggest an explicit construction of Response 2 satisfying the above properties (see FIG. 5C), but remark that there are several (potentially more efficient) ways for this task.

An important point is to ensure that while compiling W_{Resp}_{₂}, the compiler Compile₂ still allows it to read the keys. Recall that by default, Spread makes all read commands to read locations where words of the compiled programming are stored and not key positions. We can resolve this by a simple technical trick. We assume that W_{Resp}_{₂} uses a special-read command (read_key, i, j, l) for accessing the key shares, which reads the i-th word of the jth key share and stores it on register REG[l]. This extra (read_key, i, j, l) instruction does not have to be part of the CPU instructions and can be easily implemented in machine code by a simple combination of read and jump commands. In the following we denote by [symbol] ₂ the VDS (Compile₂, Challenge₂. Response₂, Verify₁).

Theorem 2.

Let [symbol] be a complete RAM and for any given programming W, let Emb(W, W_{Resp2}) be the programming, as above, which is derived by embedding to W the programming W_{Resp}_{₂} for implementing Response 2. Assuming that the adversary injects a virus virus with |virus|≧3 on consecutive locations of the random access memory and that the encryption scheme used in Compile₂ is CPA secure even against an adversary who learns all but l=ω(log k) bits of the secret key, the VDS [symbol] ₂ is secure for [symbol] in the repeated detection model with respect to the class of all non-self-modifying structured programmings.

Proof.

As in Theorem 1 we prove the properties separately.

Compilation Correctness/Self-Responsiveness:

These properties follow immediately from Lemma 1. Indeed, for compilation correctness we note that given that Emb(W, W_{Resp}) is self-restricted. Lemma 1 ensures that Definition 7 is satisfied for Q(ρ)=2ρ and for the function [symbol] computed by Spread⁻¹. Furthermore, since Emb(W, W_{Resp}) is a programming which upon input (check, c) executes the algorithm Response₂, self-responsiveness follows easily from compilation correctness.

Verification Correctness:

Lemma 1 ensures that the execution of the compiled programming \tilde{W} never accesses the key shares. Furthermore, any execution of the verification algorithm does not write anything over memory positions where key shares are stored. Thus verification correctness follows from the fact that upon [symbol] receiving (check, c) the programming Emb(W, W_{Resp}) executes algorithm Response 2 which correctly computes a double encryption of the random seed x. Thus the reconstruction process will succeed in reconstructing the correct keys. Hence verification correctness of [symbol] ₂ follows from the correctness of decryption of the encryption scheme used by Challenge₂ and Response₂.

Security in the Repeated Detection Game τ [symbol] :

Similarly to Theorem 1 we prove that an adversary Adv that passes the verification test with probability p can be used by an adversary Adv′ to break the CPA security with length bounded leakage (in the terminology of [Dodis]: “l(k)-LB CPA” for some linear l) of the encryption scheme. We recall that the l(k)-LB CPA security game ensures that the scheme is secure even when the adversary learns a linear number of bits of the secret key.

Adversary Adv′ interacts with its “l(k)-LB CPA” challenger Ch′ as follows. Adv′ initiates with Adv an execution of the game [symbol] where he plays the role of the challenger Ch as follows: Upon receiving from Adv the virus virus=(α, (w₁′, . . . , w_{ν}′) (recall that we consider a continuous virus which needs only to give the memory location α where the first word will be injected) Adv′ uses it to find a location of a key share which would be overwritten by virus in an execution of the game [symbol] . In particular, let i*=min_{i∈{α, . . . , α+ν}}{i|i∉{0,1}(mod 2n)} and let iₙ*:=i* mod n and without loss of generality assume that i* is odd (the case where i* is even can be handled symmetrically).
Adv′ instructs its “l(k)-LB CPA” challenger Ch′ to generate the secret/public key pair (SK, PK). Let SK=SK₁∥ . . . ∥SK_{n/2} where each SKᵢ={0, 1}^{L} for the l(k)-LB CPA security game. (Recall that

$$n = \frac{2 k}{L} ) .$$

Adv′ sets [symbol] _{od,i}_{ₙ}_{*}=0^{L} and for i∈(1, . . . , n)\{iₙ*} sets [symbol] _{od,i}=SK_{od,i}. Denote the odd key as [symbol] _{od}= [symbol] _{od,1}∥ . . . ∥ [symbol] _{od,i}_{ₙ}_{*-1}∥ [symbol] _{od,i*}_{ₙ}∥ [symbol] _{od,i}_{ₙ}_{*-1}∥ . . . ∥ [symbol] _{od,n}.
Adv′ runs the key generation algorithm for the “l(k)-LB CPA” scheme to generate another pair ( [symbol] ₑᵥ, [symbol] ₑᵥ) of secret/public keys. Parse [symbol] ₑᵥ as [symbol] ₑᵥ= [symbol] _{ev,1}∥ . . . ∥ [symbol] _{ev,n}, where each [symbol] _{ev,i}∈{0, 1}^{L}.
Adv′ sets [symbol] = [symbol] _{od,1}∥ [symbol] _{ev,1}∥ . . . ∥ [symbol] _{od,1}∥ [symbol] _{ev,n}

Given the above key [symbol] , Adv′ emulates the execution of Ch with the inputs (virus) received by Adv as follows. Up to round ρₚᵣₑ Adv′ runs exactly the program of Ch with the only difference that for each dth iteration of the detection procedure, Adv chooses the uniformly random message x and computes the challenge as the (double) encryption c=Enc [symbol] (Enc [symbol] (x)) writes it on the input tape, and writes x to the output tape. Since W_{Resp}_{₂} is given and the VDS is compilation-correct, Adv′ can keep track of the number of rounds that Response₂ needs for replying. At round ρₐₜₜ, Adv′ injects the virus it received from Adv onto the simulated RAM exactly as Ch would, and continues its emulation until the first invocation of the detection procedure that starts after round ρₐₜₜ. In that invocation, Adv′ chooses uniformly random x₀ and x₁, computes m₀= [symbol] (x) and m₁= [symbol] (x) and submits m₀, m₁ to its left-or-right oracle for the “l(k)-LB CPA” game. Adv′ receives from the oracle c_{b}= [symbol] (m_{b}) and is supposed to guess b. For this, Adv′ does the following. It continues the emulation of the RAM execution where the challenge is c=c_{b} and receives y. If y=m_{b}, for some b′∈{0,1} then Adv′ outputs b′ otherwise it aborts.

We next argue that if Adv succeeds in his attack with probability ρ then Adv′ also succeeds in the “l(k)-LB CPA” with probability at least ρ. To this direction, consider the hybrid setting where

$$= {SK}_{od , {i}_{n}^{*}} ,$$

i.e, [symbol] _{od}=SK. The success probability of Adv in this hybrid experiment is identical with the corresponding probability to the original experiment. Indeed, until the virus is injected, the key shares are not changed and all the challenges and responses are consistent. (This is where we use the fact that the scheme is public-key, as Adv′ has an encryption oracle which is not the case in definitions of symmetric encryption with auxiliary input.) Thus Adv overwrites the value of at lest one share of

$${SK}_{od , {i}_{n}^{*}} ,$$

obliviously of its actual value which means that it makes no difference for Adv's output whether in that position there was an actual share of

$${SK}_{od , {i}_{n}^{*}} ,$$

or the all-zero word. Now, we observe that when Adv succeeds in correctly decrypting the challenge, Adv′ also succeeds in correctly guessing the bit b. Hence, if the VDS is insecure, i.e., Adv succeeds with noticeable probability, then Adv′ also succeeds with noticeable probability which contradicts the “l(k)-LB CPA” security of the encryption scheme.
5.3 A VDS with Standard Security

The next and final step in our construction is to compile the VDS [symbol] ₂ from the previous section which is secure in the repeated detection model into a corresponding VDS which is secure in the standard model. In fact, the transformation is to a large extent generic and can be applied to most self-responsive VDSs as long as the algorithm Response can be described as an invertible RAM program, i.e., a program which at the end of its execution leaves the memory in the exact same state it was at the beginning. Note, given sufficiently memory, that this is the case for the Response algorithms described here, as they only need to compute an exclusive-OR of the key shares and then use it to decrypt the challenge. Modern CPUs can perform these operations without ever changing the contents of the memory.

Definition 11

(Invertible Programming). We say that a programming is invertible for a RAM [symbol] =(C, MEM) if the state of MEM at the end of its execution is identical to the state of MEM at the beginning of its execution.

Our transformation assumes a hash function h(•) which can be efficiently computed by an invertible programming on the RAM [symbol] This is the case for most known hash functions in contemporary CPUs. It further assumes that Response₂ is also implemented by an invertible programming. Both these assumptions are clearly true assuming sufficient memory. Under the above assumptions, we convert the VDS [symbol] ₂=(Compile₂, Challenge₂, Response₂, Verify₁) which is secure in the repeated detection model into a VDS [symbol] ₃=(Compile₃, Challenge₃, Response, Verify₃) secure in the single detection model as follows:

1. The algorithm Response 3 works as follows on input a challenge c and a programming \tilde{W}:

(a) It executes the invertible programming for h(•) which computes (on the CPU) a complete hash yₕ=h(\tilde{W}∥c) of the memory RMEM concatenated with the challenge ciphertext, outputs yₕ to the user, and erases it from the CPU. This will ensure that, even if one uses this scheme for repeated detections, the hash will be different in each invocation of the detection process.

(b) It executes the invertible programming for Response 2 and outputs its output y=Response₂ (c, \tilde{W}).

(c) It executes again the invertible programming for h(•) computes again a complete hash y′ₕ=h(\tilde{W}∥c) where \tilde{W}′ denote the current memory RMEM and outputs y′ₕ.

2. The algorithm Compile₃ is the same as Compile₂ but uses Response₃ instead of Response₂, i.e., compiles that programming Emb(W, W_{Resp}_{₃}).

3. Challenge₃ is the same as Challenge₂.

4. Verify₃ is modified as follows: Let K and z denote the inputs of Challenge₃ in the standard attack game [symbol] (FIG. 2A), and let yₕ, y and y′ₕ denote the outputs of the detection procedure. Then Verify₃(•, [symbol] ,•(yₕ, y, y′ₕ) outputs 1 if y= [symbol] and yₕ=y′ₕ, otherwise it outputs 0.

Theorem 3.

Let [symbol] be a complete RAM. If the adversary injects a virus virus with |virus|≧3 on consecutive locations of the random access memory and the encryption scheme used in Compile₂ is CPA secure even against an adversary who learns all but ∈k bits of the secret key for any constant ∈<1, then the VDS [symbol] ₃ is secure for [symbol] in the random oracle model with respect to the class of all non-self-modifying structured programmings.

Proof (sketch). The verification correctness, the compilation correctness, and the self-responsiveness of [symbol] ₃ are argued analogously to Theorem 2. In the following we argue that the scheme is secure. If the adversary plants the virus before the first evaluation of the hash function has been erased (i.e., before Step 1b of Response₃ starts), then the security of [symbol] ₂ in the repeated detection model ensures that the adversary will be caught with overwhelming probability (since Step 1b invokes Response₂ which guarantees to catch viruses injected before it starts). Otherwise, if the virus injects itself after yₕ has been erased, then in order to produce a valid reply, the virus will need to compute yₕ. Because h(•) behaves as a random oracle, and, by assumption, the adversary overwrites at least L= [symbol] (k) bits of a key share which he cannot recover, the probability that the virus outputs yₕ is negligible in k.

### 5.4. A VDS Secure Against Short Viruses

The constructions from the previous sections are secure against sufficiently long viruses (e.g., more than two words in the examples given). Nonetheless, as most modern CPU's do not use more than 256 different instructions, a single byte is sufficient for encoding all instructions. Thus we can optimize the size and/or security of the scheme in several ways. For example, we can pack more than one compiled instruction in a single word (e.g., put both the original word wᵢ and the corresponding jumpby instruction), thus allowing our scheme to detect any virus of length more than a single word. Or we can use the key sharing trick, where the last L−8 bits of each word is also used as key shares. This would provide a 2^{-(L-8)} protection even against viruses that are a single word long, as such a virus would have to overwrite L−8 bits of the secret key.

In this section we describe a construction (in the continuous injection model) which achieves security [symbol] for any desirable value of the security parameter k, independent of the virus length, and in particular even when the virus affects only part of a single word (i.e., is a few bits long). To capture such viruses that affect only part of a word, we slightly modify the virus injection model to allow for the virus to leave certain positions untouched. More precisely, a virus in the bit-by-bit injection model is, as before, a tuple virus=(\vec{α}, W)=((α_{0, . . . , α}_{ₗ₋₁}),(w₀, . . . , wₗ₋₁)), where each αᵢ∈\vec{α} is a location (address) in the memory but each wᵢ∈W is a string wᵢ∈{0, 1, ⊥}W, where ⊥ is a special symbol which does not modify the bit in the position it is injected. I.e., when the word wᵢ=(w_{i,1}, . . . , w′_{iL}) is injected on location MEM[αᵢ], if the word on location MEM[αᵢ] was w′ᵢ=(w_{i,1}′, . . . , w_{i,L}′) prior to the injection, then after the injection MEM[αᵢ]=wᵢ″=(w_{i,1}″, . . . , w_{i,L}″), where (w_{i,j}″=w_{i,j}) if w_{i,1}≠⊥ otherwise w_{i,j}″=w_{i,j}′. The continuous injection assumption can also be expressed for the bit-by-bit case: A virus virus=(α, W=(w₀, . . . wₗ₋₁)) is continuous in the bit-by-bit injection model if w₀∥ . . . ∥wₗ₋₁∈{⊥}*∥{0,1}*∥{⊥}*. By convention, we refer to the number of non-⊥ elements in a virus virus as the number of bits of the virus. At times we call this quantity the effective size of virus.

Before formally describing our construction, let us discuss the difficulty in designing a VDS which tolerates a virus of arbitrary small effective size. Depending on the actual programming we compile, an “intelligent” short virus that is injected on the position of the first operation executed might cause the RAM to jump to a location that allows the virus to take over the entire computation. This attack is admittedly unlikely, thus one might suggest that we look away from the above issue and hope that there are no intelligent viruses which are that small. This is not the approach we take here. Instead, to prevent such an attack and ensure that even such viruses will be caught we use the following idea. We use a compiler similar to Compile₃, but we include, for each program word and pair of key shares, a pair of message authentication codes (MACs) which we check every time we read a program word. For completeness, before giving the details of the compiler we introduce the MAC we are using.

A message authentication code (MAC) includes a pair of algorithms (Mac, Ver), where Mac: [symbol] × [symbol] → [symbol] is the authentication algorithm (i.e., for a message m∈ [symbol] and a key vk∈ [symbol] t=Mac(m, vk)∈ [symbol] is the corresponding authentication tag), and Ver: [symbol] × [symbol] × [symbol] →{0,1} is the verification algorithm (i.e., for a message m∈ [symbol] , an authentication tag t∈ [symbol] and a key vk∈ [symbol] Ver(m,t,vk)=1 if and only if t is a valid authentication tag for m with key vk). We let [symbol] includes all strings of length at most k, [symbol] ={0,1}^{2k} and [symbol] ={0,1}^{k}. Such a MAC can be constructed as follows. Let GF(2^{k}) be the field of characteristic two and order 2^{k}. (Every x∈GF(2^{k}) can be represented as a k-bit string and vice-versa). Let also vk=vk₁∥vk₂∈{0,1}^{2k} where vkᵢ∈{0,1}^{k} for i∈{1,2}. Then Mac(m, vk)=vk₁·m+vk₂ where + and · denote the field addition and multiplication in GF(2^{k}), respectively. (If |m|<k then pad it with appropriately many zeros.) The verification algorithm simply checks that the message, tag, and key satisfy the above condition. An important property of the above MAC is that for a given key vk, every m∈ [symbol] has a unique authentication tag that passes the verification test. Furthermore, the probability of any (even computationally unbounded) adversary learning a MAC tag to guess the corresponding key is at most 2^{-k}.

The compiler Compile₄ is similar to compiler Compile₃ from the previous section. (Recall that Compile₃ maps each wᵢ∈Emb(W, W_{Resp}_{₄}) to a pair of commands \tilde{w}_{ï}, \tilde{w}_{ï+1} where \tilde{w}_{ï+1} is the corresponding jump command.) More concretely, Compile₄ compiles the original programming W with the response algorithm Response₄ (see below) embedded in it as in the previous section (i.e., compiles Emb(W, W_{Resp}_{₄}) into a new programming \tilde{W} which interleaves additive shares K_{od}^{i,i+1} and Kₑᵥ^{i,i+1} of two encryption keys K_{od} and Kₑᵥ between any two program words wᵢ and wᵢ₊₁ of Emb(W, W_{Resp}_{₄}) and adds the appropriate jump command to ensure correct program flow. The difference is that Compile₄ also adds MAC tags tⁱ_{od}=Mac(\tilde{w}_{ï}, ∥\tilde{w}_{ï+1}, K_{od}^{i,i+1}) and tⁱₑᵥ=Mac(\tilde{w}_{ï}, ∥\tilde{w}_{ï+1}, K_{od}^{i,i+1}). To visualize it, Compile₄ expands every word wᵢ∈W as wᵢ∥“jump”∥K_{od}^{i,i+1}∥kₑᵥ^{i,i+1}∥Mac(wᵢ∥“jump”, K_{od}^{i,i+1})∥Mac(wᵢ∥jump, Kₑᵥ^{i,i+1}). Note that since each key share is of size 2k and each tag is of size k, in order for Spread to leave sufficient space for the above keys and MACs it will need to be executed with parameter

$$n = \frac{6 k}{L} .$$

As we prove, if the programming is compiled as above, then any virus, no matter how small, which is written consecutively over any positions of the above sequence even in the bit-by-bit injection setting, will either have to overwrite a long number of bits of some key Kᵢ, or will create an inconsistency in at least one of the MAC's with overwhelming probability. However, to exploit the power of the MACs we need to make sure that during the program execution, before loading any word to the CPU we first verify its MACs. To this direction, the CPU loads values from the memory RMEM to its registers via a special load instructions (read_auth, i, j), which, first, verifies both MACs of the word in location i of the memory with the corresponding keys, and only if the MACs verify, it keeps the word on the CPU. If the MAC verification fails, then (read_auth, i, j) deletes at least one of the key shares from the memory, thus introducing an inconsistency that will be caught by the detection procedure.

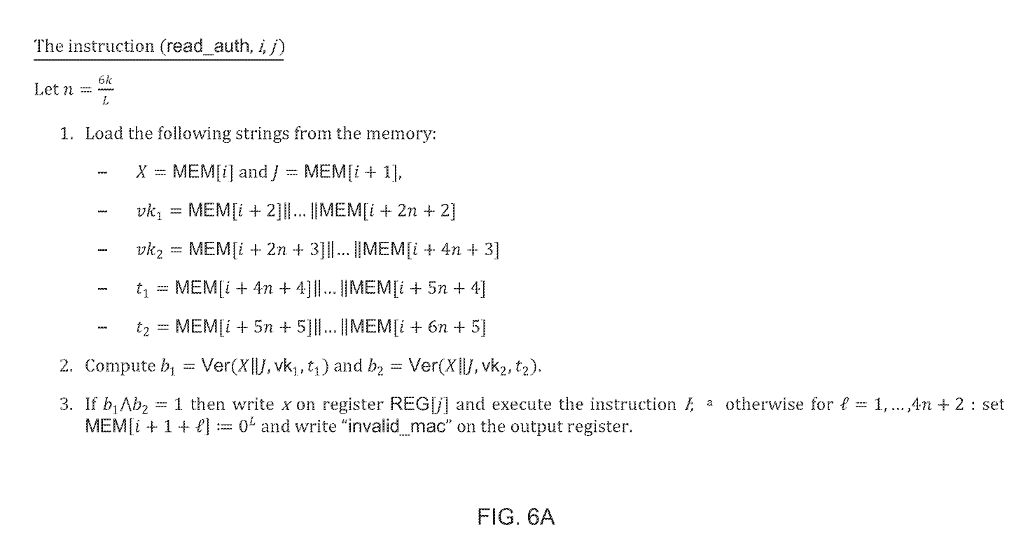

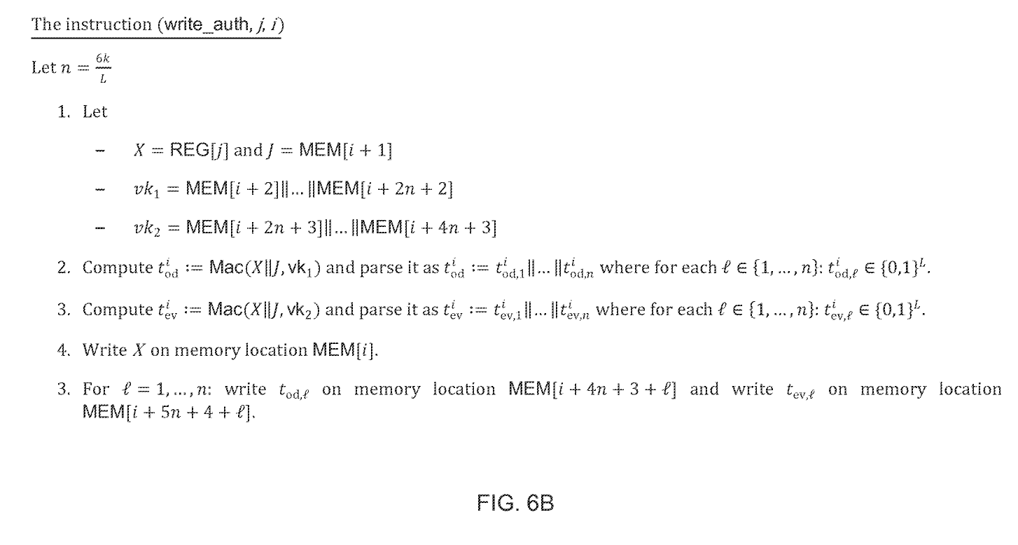

A description of instruction (read_auth, i, j) is given in FIG. 6A. Note that (read_auth, i, j) makes no tamper-resiliency assumption on the memory or the CPU. It only needs for the architecture to provide us with this simple piece of microcode. For example, the new architecture that Intel recently announced promises to allow for support of such a microcode in its next generation microchips. Moreover, we do not require that the set of instructions excludes the standard read.

Note that since the original programming W might include read instructions, the compiler replaces them by (read_auth, i, j) instructions. Furthermore, to ensure that the compiled program will not introduce inconsistencies, we replace in W every (write, j, i) instruction (which writes the contents of register j in RMEM location i) with microcode which, when writing a word in the memory it also updates the corresponding MAC tags. We denote this special instruction as write_auth and describe it in detail in FIG. 6B.

A formal description of the compiler Compile 4 is derived along the lines of Compile₃ with the above modifications. We next turn to the other three algorithms of the VDS. Challenge₄ and Verify₄ are identical to the corresponding algorithms from the previous section with the only difference that the keys used in Challenge₄ are each of size 2k instead of k. Response 4 works as Response₃ with the following difference. After the first evaluation of the hash function, and before doing anything else, Response₄ scans the entire memory to ensure that all MAC tags are correct. After this check, Response₄ continues as Response₃ would. Observe that for all (read, •, •) instructions in W_{Resp}_{₃}, the compiler Compile₄ will replace then with corresponding (read_auth, •, •) instructions. However, it will not touch the (read_key, i, j, l) instructions used for reading the keys. Therefore, the keys need not be authenticated. In the following we denote the

VDS [symbol] ₄=(Compile₄, Challenge₄, Response₄, Verify₄).

Theorem 4.

Let [symbol] be a complete RAM. If the adversary injects a virus virus on consecutive locations of the random access memory and the encryption scheme used in Compile₂ is CPA secure even against an adversary who learns any ∈k bits of the secret key for any constant ∈<1, then the VDS [symbol] ₄=(Compile₄, Challenge₄, Response₄, Verify₄).is secure for [symbol] with respect to the class of all non-self-modifying structured programmings.

Proof (Sketch).

The verification correctness, the compilation correctness, and the self-responsiveness of [symbol] ₄ are argued analogously to Theorem 3. In the following we argue that the scheme is secure. We consider the following cases about the bit-length γ (i.e., the number of bits) of virus, where for simplicity and in slight abuse of notation, in the following we write wᵢ to denote the concatenation of the word and its corresponding “jump” instruction in the compiled program. (Recall that we assume that the virus writes itself on continuous locations, but might cover parts of different, consequent, word, e.g., might start at the end of some word and continue to the beginning of the following word.)

Case 1:

The virus injection affects at least two (consecutive) program words w and wᵢ₊₁. In this case, the virus will overwrite all the key material between wᵢ and wᵢ₊₁. This makes it information theoretically impossible for the attacker to recover the key thus, similarly to the proof of Theorem 3, the attacker will fail in the detection procedure.

Case 2:

The virus affects exactly one program word wᵢ. First we observe that if the virus extends only to the left of wᵢ or only writes itself on top of wᵢ, i.e., does not affect the keys used to compute wᵢ's MACs, then the security of the MAC scheme ensures that with overwhelming probability, the MAC will fail. Hence as soon as wᵢ, is read, the virus will be exposed. Note that at the latest during the detection process wᵢ, will be read as Response₄ first scans the entire memory for MAC failures and then invokes Response₃.

For the remainder of this proof assume that the virus extends to the right of wᵢ. Using the notation from our description, the words to the right of wᵢ, are K_{od}^{i,i+1}, Kₑᵥ^{i,i+1}, t_{od}ⁱ=Mac(wᵢ, K_{od}^{i,i+1}), and tₑᵥⁱ=Mac(wᵢ, Kₑᵥ^{i,i+1}). Since the virus modifies wᵢ, if it leaves Kₑᵥ^{i,i+1} and tₑᵥⁱ untouched, it will fail the MAC test. Thus the virus needs to at least modify Kₑᵥ^{i,i+1}. However, by the continuous injection assumption, this implies that the virus needs to completely overwrite K_{od}^{i,i+1} (as it is written in-between m and Kₑᵥ^{i,i+1}). But, in this case it will be information theoretically impossible for the attacker to recover this key share as the only value in the memory that is related to this key share is the MACs Mac(wᵢ; K_{od}^{i,i+1}). Thus, similarly to the proof of Theorem 3, the attacker will fail in the detection procedure.

Case 3:

The virus injection does not modify any program word (i.e., it only overwrites keys and/or MAC tags). By the continuous injection assumption, this implies that the virus is injected to the space between two program words wᵢ, and wᵢ₊₁. Using our notation, let K_{od}^{i,i+1}, Kₑᵥ^{i,i+1}, t_{od}ⁱ=Mac(wᵢ; K_{od}^{i,i+1}, and tₑᵥⁱ=Mac(wᵢ, Kₑᵥ^{i,i+1}) denote the memory contents between wᵢ, and wᵢ₊₁. We consider the following cases: (A) the virus overwrites part of K_{od}^{i,i+1} or Kₑᵥ^{i,i+1}, and (B) the virus overwrites only MACs. In case (A) we point out that the virus is never executed since by construction the program counter will never point to key locations for executing an instruction. Since the key shares are part of an additive sharing of the decryption keys, any change to any one of the shares also changes the decryption key thus, by the correctness of decryption of the underlying scheme, with high-probability the response algorithm will return a false decryption and the virus will be caught. In case (B) things are even more simple, since the injective nature of our MAC ensures that the tags are uniquely defined by the word w, and the keys K_{od}^{i,i+1} and Kₑᵥ^{i,i+1}. Thus any modification to the MAC tag will be detected once w; is read.

### 6. Further Extensions

Although the detailed description contains many specifics, these should not be construed as limiting the scope of the invention but merely as illustrating different examples and aspects of the invention. It should be appreciated that the scope of the invention includes other embodiments, optimizations and extensions not discussed in detail above, some of which are discussed below.

Key Share Insertion.

The example solutions described above inserted one or two key shares between every two words of original programming. Key shares can also be interleaved with original program words in other ways. For example, the original programming might be spread so that up to N original program words can still be contiguous, where N is some preselected integer. N=1 in the above examples, but it could also be greater than 1. Conversely, key share insertion may be limited so that not more than M key shares are inserted between any two adjacent original program words. M=1 or 2 in the above examples, but could take on other values. In another approach, key shares can be inserted in a random fashion into the original programming, especially if the insertion is such that an injection of malware will disturb the key shares with high probability. The key shares also do not all have to be from a single secret key; they can be key shares from a set of secret keys.

Allowing Injection on CPU Registers.

The example solutions described above protect against injection of malware on the memory RMEM but not on the CPU. Nonetheless, the general VDS [symbol] ₃ which protects against arbitrarily small and non-continuous injection can be adapted to protect also against injection directly on the CPU registers. One way for this would be as follows: apply the compilation to the entire memory of the system, including the CPU registers. The reconstruction will then require the machine to read also the key shares written on these registers.

Compiling New Software from the Hard Drive.

As described, our virus injection mechanisms treat the RAM as a closed system, i.e., values are loaded to the memory RMEM once and no new data is loaded from the hard drive during the computation. This might seem somewhat restrictive, and we believe that it can circumvented by securing the contents of the hard drive using standard cryptographic mechanisms, i.e., encryption and message authentication. The executed software would then verify authenticity of data loaded from the hard drive. This will cause some slowdown on loading more data from the hard drive, but need only be applied to critical data.

Sublinear Word Size.

Our results assume that the word length L is linear in the security parameter. This is realistic in modern computer architectures where the word size is 64 bits, as values for security parameter which is useful in practice are 128-256 bits. We point out however that our results can be easily extended to architectures with smaller word size. In such a scenario, a “not too short” virus (in the terminology of Section 5) would be one that is Lw(log k)-bits long. Indeed, such a virus would have to overwrite at least w(log k) bits from different key shares which would make the guessing probability of an adversary negligible in k.

Non-Continuous Injection.

The VDS's described here are secure assuming the virus injects itself on consecutive memory locations but with appropriate adaptations our techniques can be extended to tolerate non-continuous injection. As an example, by randomizing the positions on which the code words are written between the key shares, we can achieve that the adversary injecting a moderate virus will overwrite a big part of a key share or, in case of the last MAC construction, will create a MAC inconsistency.

Independent MAC Usage.

As another variant, the concepts describe in Section 5.4 regarding the use of MACs can be implemented regardless of whether the virus detection based on interspersed key shares is also implemented. The reverse is also true. Although implementing only one or the other will result in less security than implementing both, for many applications this level of security may be sufficient or other security measures may be additionally used to provide further security.

Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

In alternate embodiments, the invention is implemented in computer hardware, firmware, software, and/or combinations thereof. Apparatus of the invention can be implemented in a computer program product tangibly embodied in a machine-readable storage device for execution by a programmable processor: and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

1. A computer-implemented method for compiling an original program into a modified program that is resistant to virus injection, the original program stored as words in a computer memory, the method comprising:
inserting a plurality of key shares for a key set at memory locations between the original program words, wherein the key set comprises one or more secret keys, and the key set is lost if any of the key shares are modified; and
modifying the original program so that execution of the modified program produces a same result as execution of the original program;
wherein virus injection into a contiguous block of words will modify at least one key share with high probability, and executing a challenge-response protocol based on the key set will verify whether any of the key shares has been modified.

2. The computer-implemented method of claim 1 wherein the modified program can be proven to detect any virus injection into a contiguous block of N or more words, where N is a preselected integer greater than or equal to 3.

3. The computer-implemented method of claim 2 wherein N=3.

4. The computer-implemented method of claim 1 wherein inserting the plurality of key shares comprises inserting key shares between original program words so that not more than N original program words will be contiguous in the modified program, where N is a preselected integer.

5. The computer-implemented method of claim 4 wherein inserting the plurality of key shares comprises inserting key shares between original program words so that no original program words are contiguous in the modified program.

6. The computer-implemented method of claim 1 wherein inserting the plurality of key shares comprises inserting key shares at random memory locations between original program words.

7. The computer-implemented method of claim 1 wherein inserting the plurality of key shares comprises:
spreading out the original program words to create unused memory locations between the original program words; and
inserting key shares at the unused memory locations.

8. The computer-implemented method of claim 1 wherein inserting the plurality of key shares comprises inserting key shares so that not more than M key shares is inserted between original program words, where M is a preselected integer.

9. The computer-implemented method of claim 8 wherein inserting the plurality of key shares comprises inserting key shares so that not more than two key shares is inserted between original program words.

10. The computer-implemented method of claim 8 wherein inserting the plurality of key shares comprises inserting key shares so that not more than one key share is inserted between original program words.

11. The computer-implemented method of claim 1 wherein modifying the original program comprises inserting instructions to jump over memory locations storing key shares.

12. The computer-implemented method of claim 11 wherein inserting instructions to jump over memory locations storing key shares comprises inserting jump instructions immediately after original program words.

13. The computer-implemented method of claim 1 wherein modifying the original program comprises modifying addresses for jump instructions in the original program to account for changes in addresses resulting from insertion of the key shares.

14. The computer-implemented method of claim 1 wherein the key set comprises at least two secret keys, and the challenge-response protocol prevents simultaneous existence of all secret keys.

15. The computer-implemented method of claim 1 further comprising:
inserting message authentication codes (MACs) at memory locations between the original program words, each MAC authenticating associated program words using associated key shares.

16. The computer-implemented method of claim 15 wherein, upon execution of the modified program, a fetch cycle of the program execution will fetch one or more program words, the associated MAC and the key shares associated with the MAC, wherein the fetched program words can be authenticated using the fetched MAC and key shares.

17. The computer-implemented method of claim 16 wherein the fetch cycle fetches a predefined number of words from memory, the predefined number of words including a fixed number of program words, a fixed number of words of key shares, and the MAC.

18. The computer-implemented method of claim 15 wherein the MAC is a hash of a combination of the associated program words with a hash of the associated key shares.

19. The computer-implemented method of claim 1 wherein the original program is binary code, inserting the plurality of key shares comprises inserting the plurality of key shares between words of the binary code, and modifying the original program comprises modifying the binary code.

20. The computer-implemented method of claim 1 wherein the program includes instructions and data.

21-40. (canceled)
